(19) United States
(12) Patent Application Publication
(10) Pub. No.: US 2007/0217383 A1
(43) Pub. Date: Sep. 20, 2007

(54) Wireless LAN mobile station, wireless LAN system, and method and program of controlling handover

(75) Inventor: Yukio Mitani, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/723,199

(22) Filed: Mar. 16, 2007

(30) Foreign Application Priority Data
Mar. 16, 2006 (JP) 073166/2006

(51) Int. Cl. H04Q 7/24

(52) U.S. Cl. 370/338

(57) ABSTRACT

A wireless LAN mobile station stores a threshold value serving as a criterion for executing a handover process and which is increased on the basis of other conditions in addition to a received signal strength indicator (RSSI) so as to facilitate the execution of the handover process and expedite the breaking of association with the current association device, thereby allowing the wireless LAN mobile station to make an association with an optimal association device. In the wireless LAN mobile station 1-1 to 1-N (N is an arbitrary integer), it is controlled in such a manner that the communication quality level of information transmitted and received between the wireless LAN mobile station and the wireless LAN base station 10-1 to 10-N serving as the association device associated with the wireless LAN mobile station is measured and the threshold value serving as a criterion for executing the handover process is increased by a predetermined value when it is determined that the measured communication quality level is smaller than a predetermined communication quality level.

### BACKGROUND OF THE INVENTION

1. Field of the Invention

The present invention relates to a wireless LAN system including a plurality of wireless LAN base stations and a plurality of wireless LAN mobile stations, and more particularly, to wireless LAN mobile stations executing a handover at a suitable time when a mobile station moves among base stations, a wireless LAN system including wireless LAN mobile stations, and a method and a computer program for controlling the handover of the mobile stations.

2. Description of the Related Art

Recently, a wireless LAN (local area network) system represented by IEEE (Institute of Electrical and Electronics Engineers) 802.11x (“x” refers to a, b, g, or the like) is widely used. As shown in FIG. 1, the wireless LAN system includes wireless LAN mobile stations 1-1 to 1-N (N is an arbitrary integer), wireless LAN base stations 10-1 to 10-N (N is also arbitrary and not related to the number of mobile stations), and a centralized management and control device 20, and the device 20 controls the base stations 10-1 to 10-N so that the base stations 10-1 to 10-N communicate with the mobile stations 1-1 to 1-N located within coverage areas (cell) of the base stations 10-1 to 10-N.

In the wireless LAN system shown in FIG. 1, when the user of one of the wireless LAN mobile stations 1-1 to 1-N, for example, of a wireless LAN mobile station 1-1 shown in FIG. 2 has moved from a position “A” where the mobile station can wirelessly communicate with a first wireless LAN base station 10-1 to a position “B” where it can wirelessly communicate with a second wireless LAN base station 10-2, and the received signal strength indicator (RSSI) of a radio signal that the mobile station has received from the base station 10-1 has become weak, the mobile station executes a handover process. Then, the mobile station breaks the connection (association) with the base station 10-1 that provides a weaker RSSI and then makes a connection (association) with the base station 10-2 that provides a stronger RSSI.

The term “handover” refers to a switching control for continuing communication for the wireless LAN mobile stations 1-1 to 1-N when a mobile station moves from the coverage area (cell) of the first wireless LAN base station 10-1 to the coverage area (cell) of the second wireless LAN base station 10-2 in a wireless LAN area composed of a plurality of coverage areas (cells) of the wireless LAN base stations 10-1 to 10-N.

Specifically, as shown in FIG. 2, when the wireless LAN mobile station 1-1 has moved from the position “A” to the position “B” and the RSSI of the radio signal received from the first wireless LAN base station 10-1 with which the wireless LAN mobile station 1-1 is currently communicating has decreased to a value equal to or smaller than a threshold value that serves as a criterion for executing the handover, the mobile station searches for the nearby second wireless LAN base station 10-2 that provides a stronger RSSI and can be connected to the wireless LAN mobile station 1-1. When the wireless LAN mobile station 1-1 has discovered the second wireless LAN base station 10-2 that provides a stronger RSSI, an adjustment for the wireless LAN mobile station 1-1 to communicate with the second wireless LAN base station 10-2 so as to switch to the second wireless LAN base station 10-2, thereby preventing the wireless LAN mobile station 1-1 left disconnected.

The wireless LAN mobile station 1-1 to 1-N suffers an interruption of several milliseconds during voice communication at the handover, and it is thus desirable to construct the wireless LAN mobile station to execute the handover process at appropriate timing.

Next, a series of operations performed by the wireless LAN system shown in FIG. 1 in the handover process will be described with reference to FIG. 3. FIG. 3 is a diagram showing exemplary operations performed by the wireless LAN system shown in FIG. 1 in the handover process. It is assumed that the wireless LAN system shown in FIG. 1 is based on the IEEE 802.11 standard.

First, a mobile station transmits a probe request signal to the base station 10-1 (step A1). Upon receiving the probe request signal from the mobile station, the base station 10-1 transmits a probe response signal to the mobile station (step A2).

Upon receiving the probe response signal, the mobile station recognizes that there is a base station that can communication with the mobile station, and transmits an authentication request signal to the base station 10-1 (step A3). Upon receiving the authentication request signal from the mobile station, the base station 10-1 transmits an authentication response signal to the mobile station (step A4).

Upon receiving the authentication response signal, the mobile station transmits an association request signal to the base station 10-1 and asks the base station 10-1 to establish communication with the mobile station (step A5). Upon receiving the association request signal from the mobile station, the base station 10-1 transmits an association response to the mobile station and permits the mobile station to communicate with the base station 10-1 (step A6). With this arrangement, the mobile station can communicate with the base station 10-1 (step A7).

Next, when the mobile station determines that the RSSI of the radio signal received from the base station 10-1 decreases to a value equal to or smaller than a threshold value (step A8), the mobile station executes the handover process and searches for other base stations 10-2 to 10-N that provide a stronger RSSI. The mobile station sequentially transmits the probe request signal to each of radio channels defined by the IEEE 802.11 standard and performs a scanning operation on other base stations (step A9). In this way, the base station 10-2 can receive the probe request signal from the mobile station.

Upon receiving the probe request signal from the mobile station, the base station 10-2 transmits a probe response signal to the mobile station (step A10). Upon receiving the probe response signal, the mobile station recognizes that there is a base station that can establish communication with the mobile station, and transmits an authentication request signal to the base station 10-2 (step A11). Upon receiving the authentication request signal from the mobile station, the base station 10-2 transmits an acknowledgement response signal to the mobile station (step A12).

Upon receiving the acknowledgement response signal from the base station 10-2, the mobile station transmits an association request signal to the base station 10-2 and asks the base station 10-2 to establish communication with the mobile station (step A13). Upon receiving the association request signal from the mobile station, the base station 10-2 transmits an association response to the mobile station and permits the mobile station to communication with the base station 10-2 (step A14). With this arrangement, the mobile station can communicate with the base station 10-2 (step A15).

In this way, when the mobile station determines that the RSSI of the radio signal received from the base station 10-1 decreased to a value equal to or smaller than a threshold value, the mobile station executes the handover process and searches for other base stations 10-2 to 10-N that provide a stronger RSSI. When the mobile station performs a scanning operation on the base stations 10-2 to 10-N and finds the base station 10-2 that provides a stronger RSSI, the mobile station makes a connection (association) with the base station 10-2 that provides a stronger RSSI.

The wireless LAN base stations 10-1 to 10-N, as shown in FIGS. 1 and 2, are designed in such a manner that coverage areas (cells) of adjacent base stations overlap. Therefore, as shown in FIG. 2, the mobile station in the “overlapping region” receives radio signals from both the base stations 10-1 and 10-2.

As described above, a conventional wireless LAN mobile station executes the handover process when the RSSI of the radio signal received from the base station 10-1 decreased to a value equal to or smaller than a threshold value. In order for the mobile station 1-1 to make a connection (association) with the optimal base station 10-2 that provides a stronger RSSI, it is required that the RSSI of the radio signal received from the base station 10-1 be equal to or smaller than the threshold value.

Even when there is an optimal base station 10-2 providing a stronger RSSI, if the RSSI of the radio signal received from the base station 10-1 is not equal to or smaller than the threshold value, the mobile station 1-1 cannot make a connection (association) with the base station 10-2 that provides a stronger RSSI. Therefore, if only the RSSI is took into consideration, it is substantially impossible to make a connection (association) with the optimal base station 10-2.

Patent document 1 (Japanese Patent Application Laid-Open No. 2005-175932) discloses a wireless LAN handover processing system which includes a plurality of wireless LAN base stations and at lease one wireless LAN terminal moving among wireless LAN base stations. In the wireless LAN handover processing system, the wireless LAN terminal switches to another wireless LAN base station providing a stronger reception signal level when a current reception signal level becomes low, while performing an operation of transmitting and receiving data and an operation of scanning the reception signal level of the wireless LAN base station. Specifically, the wireless LAN terminal voluntarily starts a handover process when the current reception signal level becomes lower, and switches to another wireless LAN base station providing a stronger reception signal level, thereby shortening a time for switching to another wireless LAN base station.

Patent document 2 (WO99/34627) discloses a wireless communication device which includes a radio unit connected to a transmitter and receiver antenna, and a control unit comparing either or both of a field intensity level and a link quality measured by the radio unit with threshold values, outputting a handover instruction to the radio unit when the measured field intensity level or the measured link quality is equal to or smaller than corresponding threshold value, and decreasing the threshold value when a handover process performed in accordance with the handover instruction was unsuccessful. In the wireless communication device, a communication quality level is improved by decreasing frequency of handovers when there is no base station available for a handover.

Patent document 3 (WO 00/01174) discloses a mobile communication terminal which includes electric field level measuring section that measures an electric field level of signals received from a base radio station, bit error rate measuring section that measures a bit error rate of the signals received from the base radio station, electric field level correcting section that corrects the electric field level measured by the electric field level measuring section, on the basis of the bit error rate measured by the bit error rate measuring section, and control section that controls a handover between radio communication channels, on the basis of the electric field level corrected by the electric field correcting section. In the mobile communication terminal, since the mobile communication terminal is allowed to select the best base radio station cell even in a fading environment, it is possible to decrease the number of handover processes as much as possible, suppress deterioration in service quality, and reduce the traffic of control signals.

Patent document 4 (Japanese Patent Application Laid-Open No. 2001-078242) discloses a handoff control method in which a handoff process is performed when a mobile station has received a reference signal having a signal level exceeding a preset threshold value from another wireless base station and the another wireless base station has also received a signal transmitted from the mobile station. In the handoff control method, the handoff process is performed on the basis of the threshold value which is set to the mobile station and varies in accordance with the quality of a radio link between the mobile station and the base station, thereby increasing the probability of success in the handoff, restricting unnecessary execution of the handoff process, and maintaining a stable call condition.

Non-patent document 1 (Yukio MITANI and Four others, Wireless LAN system, “UNIVERGE WL Series”, NEC Journal of Advanced Technology, 2005, No. 5, Vol. 58, pp. 58-60) discloses an example of a wireless LAN system that is being developed by the present inventors.

In patent document 1, the wireless LAN terminal actively starts a handover process when the level of a signal received from the wireless LAN base station currently connected to the wireless LAN terminal become low and switches to another wireless LAN base station providing a stronger reception signal level. Specifically, in patent document 1, the determination of whether to voluntarily start the handover process is made only on the basis of the condition of the reception signal level. However, it is not considered that the determination of whether to actively start the handover process is made on the basis of other conditions in addition to the condition of the reception signal level.

In patent document 2, the threshold value serving as a criterion for executing the handover process is changed. Specifically, the threshold value is changed in accordance with the number of unsuccessful handover processes, thereby decreasing the frequency of the handover processes and improving communication quality level. However, it is not considered that the threshold value is changed to facilitate the execution of the handover process.

In patent document 3, the electric field level is corrected on the basis of a bit error rate, thereby controlling the handover between the radio communication channels on the basis of the corrected electric field level. Specifically, since the handover between the radio communication channels is controlled on the basis of the corrected electric field level, the number of handovers are decreased as much as possible, deterioration in service quality is avoided, and the traffic of control signals is reduced. However, it is not considered that the threshold value is changed to facilitate the handover.

In patent document 4, the threshold value set to the mobile station varies and the handoff process is performed on the basis of the varying threshold value, thereby increasing the probability of success in the handoff. Specifically, the threshold value decreases to an extent that the mobile station can securely receive the reference signal from the wireless base station currently associated with the mobile station, thereby allowing the mobile station to receive the reference signal from the wireless base station and thus increasing the probability of success in the handoff. However, it is not considered that the threshold value is changed to facilitate the execution of the handover process and to expedite the breaking of the current association with the wireless base station.

### SUMMARY OF THE INVENTION

In light of the foregoing problems, exemplary aspects of the present invention include providing a wireless LAN mobile station, a wireless LAN system, and a method and a program for controlling handover, in which a threshold value serving as a criterion for executing a handover process is increased on the basis of other conditions in addition to a received signal strength indicator (RSSI) so as to facilitate the execution of the handover process and expedite the breaking of communication with the currently associated device, thereby allowing a wireless LAN mobile station to establish communication with an optimal device.

In order to achieve the above-mentioned feature, the exemplary embodiments include the following aspects.

There is provided a wireless LAN mobile station including a received signal strength measuring section that measures the value of a received signal strength indicator; and a handover executing section that compares the value of the received signal strength indicator with a threshold value serving as a criterion for executing a handover and executing the handover when the value of the received signal strength indicator is equal to or smaller than the threshold value, in which the wireless LAN mobile station further includes communication quality level measuring section that measures a communication quality level of information that is transmitted or received between the wireless LAN mobile station and an association device associated with the wireless LAN mobile station; and a threshold value changing section that increases the threshold value by a predetermined value when the communication quality level is smaller than the predetermined communication quality level.

The threshold value changing section may change the threshold value to an initial value or decrease the threshold value by a predetermined value when the communication quality level is equal to or greater than a predetermined communication quality level after the threshold value is increased by a predetermined value.

There is also provided a wireless LAN mobile station including a received signal strength measuring section that measures the value of a received signal strength indicator; and a handover executing section that compares the value of the received signal strength indicator measured by the received signal strength measuring section with a threshold value serving as a criterion for executing a handover and executing the handover when the value of the received signal strength indicator is equal to or smaller than the threshold value, in which the wireless LAN mobile station further includes a communication quality level measuring section that measures a communication quality level of information that is transmitted or received between the wireless LAN mobile station and an association device associated with the wireless LAN mobile station; a managing section that manages an unsatisfactory condition for the predetermined communication quality level and the value of a received signal strength indicator so that they are correlated with each other; and a threshold value changing section that, when the communication quality level measured by the communication quality level measuring section corresponds to the unsatisfactory condition for the predetermined communication quality level being managed by the managing section, acquires the received signal strength indicator value correlated with the unsatisfactory condition for the predetermined communication quality level, and changes the threshold value to the acquired received signal strength indicator value, wherein the managing section manages the unsatisfactory condition for the predetermined communication quality level so that a poorer unsatisfactory condition for the predetermined communication quality level is correlated with a higher received signal strength indicator value, and wherein, as the communication quality level measured by the communication quality level measuring section corresponds to the poorer unsatisfactory condition for the predetermined communication quality level, the threshold value changing section changes the threshold value to a higher received signal strength indicator value.

The communication quality level measuring section may measure the communication quality level by using at least one of an SNR measuring section that measures an SNR (signal to noise ratio); a BER measuring section that measures a BER (bit error rate); a PER measuring section that measures a PER (packet error rate); and a data retransmission rate measuring section that measures a data retransmission rate of information.

The threshold value changing section may be configured to determine that the communication quality level is smaller than the predetermined communication quality level when the SNR measured by the SNR measuring section is determined to be equal to or smaller than the predetermined threshold value, and the communication quality level is equal to or greater than the predetermined communication quality level when the SNR measured by the SNR measuring section is determined to be greater than the predetermined threshold value; the communication quality level is smaller than the predetermined communication quality level when the BER measured by the BER measuring section is determined to be equal to or smaller than the predetermined threshold value, and the communication quality level is equal to or greater than the predetermined communication quality level when the BER measured by the BER measuring section is determined to be greater than the predetermined threshold value; the communication quality level is smaller than the predetermined communication quality level when the PER measured by the PER measuring section is determined to be equal to or smaller than the predetermined threshold value, and the communication quality level is equal to or greater than the predetermined communication quality level when the PER measured by the PER measuring section is determined to be greater than the predetermined threshold value; and/or the communication quality level is smaller than the predetermined communication quality level when the data retransmission rate measured by the data retransmission rate measuring section is determined to be equal to or smaller than the predetermined threshold value, and the communication quality level is equal to or greater than the predetermined communication quality level when the data retransmission rate measured by the data retransmission rate measuring section is determined to be greater than the predetermined threshold value.

The wireless LAN mobile station may further include threshold value change determining section that determines whether the threshold value changing section is to change the threshold value.

The threshold value change determining section may allow the threshold value changing section to change the threshold value when a radio signal of which the received signal strength indicator value is greater than that of an associated device associated with the wireless LAN mobile station has been received by the wireless LAN mobile station.

There is also provided a wireless LAN system configured with a plurality of wireless LAN base stations and a wireless LAN mobile station located under the plurality of wireless LAN base stations, in which the wireless LAN mobile station includes a received signal strength measuring section that measures the value of a received signal strength indicator; a handover executing section that compares the value of the received signal strength indicator measured by the received signal strength measuring section with a threshold value serving as a criterion for executing a handover and executing the handover when the value of the received signal strength indicator is equal to or smaller than the threshold value; s communication quality level measuring section that measures a communication quality level of information which is transmitted or received between the wireless LAN mobile station and an association device associated with the wireless LAN mobile station; and a threshold value changing section that increases the threshold value by a predetermined value when the communication quality level measured by the communication quality level measuring section is smaller than the predetermined communication quality level.

The wireless LAN mobile station may change the threshold value to an initial value or decrease the threshold value by a predetermined value when the communication quality level measured by the communication quality level measuring section is equal to or greater than a predetermined communication quality level after the threshold value is increased by a predetermined value.

There is also provided a wireless LAN system configured with a plurality of wireless LAN base stations and a wireless LAN mobile station communicating with the plurality of wireless LAN base stations, in which the wireless LAN mobile station includes a received signal strength measuring section that measures the value of a received signal strength indicator; a handover executing section that compares the value of the received signal strength indicator measured by the received signal strength measuring section with a threshold value serving as a criterion for executing a handover and executing the handover when the value of the received signal strength indicator is equal to or smaller than the threshold value; a communication quality level measuring section that measures a communication quality level of information which is transmitted or received between the wireless LAN mobile station and an association device associated with the wireless LAN mobile station; a managing section that manages an unsatisfactory condition for the predetermined communication quality level and the value of a received signal strength indicator so that they are correlated with each other; and a threshold value changing section, when the communication quality level measured by the communication quality level measuring section corresponds to the unsatisfactory condition for the predetermined communication quality level being managed by the managing section, acquiring the received signal strength indicator value correlated with the unsatisfactory condition for the predetermined communication quality level, and changing the threshold value to the acquired received signal strength indicator value, wherein the managing section manages the unsatisfactory condition for the predetermined communication quality level so that a poorer unsatisfactory condition for the predetermined communication quality level is correlated with a higher received signal strength indicator value, and wherein, as the communication quality level measured by the communication quality level measuring section corresponds to the poorer unsatisfactory condition for the predetermined communication quality level, the threshold value changing section changes the threshold value to a higher received signal strength indicator value.

The wireless LAN mobile station may measure the communication quality level by using at least one of an SNR measuring section that measures an SNR (signal to noise ratio); a BER measuring section that measures a BER (bit error rate); a PER measuring section that measures a PER (packet error rate); and a data retransmission rate measuring section that measures a data retransmission rate of information.

The wireless LAN mobile station may be configured to determine that the communication quality level is smaller than the predetermined communication quality level when the SNR measured by the SNR measuring section is determined to be equal to or smaller than the predetermined threshold value, and the communication quality level is equal to or greater than the predetermined communication quality level when the SNR measured by the SNR measuring section is determined to be greater than the predetermined threshold value; the communication quality level is smaller than the predetermined communication quality level when the BER measured by the BER measuring section is determined to be equal to or smaller than the predetermined threshold value, and the communication quality level is equal to or greater than the predetermined communication quality level when the BER measured by the BER measuring section is determined to be greater than the predetermined threshold value; the communication quality level is smaller than the predetermined communication quality level when the PER measured by the PER measuring unit is determined to be equal to or smaller than the predetermined threshold value, and the communication quality level is equal to or greater than the predetermined communication quality level when the PER measured by the PER measuring unit is determined to be greater than the predetermined threshold value; and/or the communication quality level is smaller than the predetermined communication quality level when the data retransmission rate measured by the data retransmission rate measuring section is determined to be equal to or smaller than the predetermined threshold value, and the communication quality level is equal to or greater than the predetermined communication quality level when the data retransmission rate measured by the data retransmission rate measuring section is determined to be greater than the predetermined threshold value.

The wireless LAN mobile station further may include a threshold value change determining section that determines whether the threshold value changing section is to change the threshold value.

The wireless LAN mobile station may allow the threshold value changing section to change the threshold value when a radio signal of which the received signal strength indicator value is greater than that of an associated device associated with the wireless LAN mobile station has been received by the wireless LAN mobile station.

There is also provided a method for controlling a handover in a wireless LAN mobile station in which the value of a received signal strength indicator is measured, the measured received signal strength indicator value is compared with a threshold value serving as a criterion for executing the handover, and the handover is executed when the received signal strength indicator value is equal to or smaller than the threshold value, the method comprising a communication quality level measuring step of measuring a communication quality level of information which is transmitted or received between the wireless LAN mobile station and an association device associated with the wireless LAN mobile station; and a threshold value changing step of increasing the threshold value by a predetermined value when the communication quality level measured by the communication quality level measuring step is smaller than a predetermined communication quality level.

The threshold value changing step may change the threshold value to an initial value or decrease the threshold value by a predetermined value when the communication quality level measured by the communication quality level measuring section is equal to or greater than a predetermined communication quality level after the threshold value is increased by a predetermined value.

There is also provided a method for controlling a handover in a wireless LAN mobile station in which the value of a received signal strength indicator is measured, the measured received signal strength indicator value is compared with a threshold value serving as a criterion for executing the handover, and the handover is executed when the received signal strength indicator value is equal to or smaller than the threshold value, in which the wireless LAN mobile station includes managing section that manages an unsatisfactory condition for the predetermined communication quality level and the value of a received signal strength indicator so that they are correlated with each other, in which the method is configured to allow the wireless LAN mobile station to perform a process including a communication quality level measuring step of measuring a communication quality level of information which is transmitted or received between the wireless LAN mobile station and an association device associated with the wireless LAN mobile station; and a threshold value changing step of, when the communication quality level measured by the communication quality level measuring section corresponds to the unsatisfactory condition for the predetermined communication quality level, acquiring the received signal strength indicator value correlated with the unsatisfactory condition for the predetermined communication quality level, and changing the threshold value to the acquired received signal strength indicator value, wherein the managing section manages the unsatisfactory condition for the predetermined communication quality level so that a poorer unsatisfactory condition for the predetermined communication quality level is correlated with a higher received signal strength indicator value, and wherein, as the communication quality level measured in the communication quality level measuring step corresponds to the poorer unsatisfactory condition for the predetermined communication quality level, the threshold value changing step is configured to change the threshold value to a higher received signal strength indicator value.

The communication quality level measuring step may allow the wireless LAN mobile station to measure the communication quality level by using at least one of an SNR measuring step of measuring an SNR (signal to noise ratio); a BER measuring step of measuring a BER (bit error rate); a PER measuring step of measuring a PER (packet error rate); and a data retransmission rate measuring step of measuring a data retransmission rate of information.

The threshold value changing step may determine that the communication quality level is smaller than the predetermined communication quality level when the SNR measured in the SNR measuring step is determined to be equal to or smaller than the predetermined threshold value, and the communication quality level is equal to or greater than the predetermined communication quality level when the SNR measured in the SNR measuring step is determined to be greater than the predetermined threshold value; the communication quality level is smaller than the predetermined communication quality level when the BER measured in the BER measuring step is determined to be equal to or smaller than the predetermined threshold value, and the communication quality level is equal to or greater than the predetermined communication quality level when the BER measured in the BER measuring step is determined to be greater than the predetermined threshold value; the communication quality level is smaller than the predetermined communication quality level when the PER measured in the PER measuring step is determined to be equal to or smaller than the predetermined threshold value, and the communication quality level is equal to or greater than the predetermined communication quality level when the PER measured in the PER measuring step is determined to be greater than the predetermined threshold value; and/or the communication quality level is smaller than the predetermined communication quality level when the data retransmission rate measured in the data retransmission rate measuring step is determined to be equal to or smaller than the predetermined threshold value, and the communication quality level is equal to or greater than the predetermined communication quality level when the data retransmission rate measured in the data retransmission rate measuring step is determined to be greater than the predetermined threshold value.

The method may allow the wireless LAN mobile station to perform a process including a threshold value change determining step of determining whether to change the threshold value in the threshold value changing step.

The threshold value change determining step may change the threshold value in the threshold value changing step when a radio signal of which the received signal strength indicator value is greater than that of an associated device associated with the wireless LAN mobile station has been received by the wireless LAN mobile station.

There is also provided a computer program for controlling a handover in a wireless LAN mobile station in which the value of a received signal strength indicator is measured, the measured received signal strength indicator value is compared with a threshold value serving as a criterion for executing the handover, and the handover is executed when the received signal strength indicator value is equal to or smaller than the threshold value, the program causing a computer to perform a process including a communication quality level measuring operation of measuring a communication quality level of information which is transmitted or received between the wireless LAN mobile station and an association device associated with the wireless LAN mobile station; and a threshold value changing operation of increasing the threshold value by a predetermined value when the communication quality level measured by the communication quality level measuring operation is smaller than a predetermined communication quality level.

The threshold value changing operation may change the threshold value to an initial value or decrease the threshold value by a predetermined value when the communication quality level measured by the communication quality level measuring operation is equal to or greater than a predetermined communication quality level after the threshold value is increased by a predetermined value.

There is also provided a computer program for controlling a handover in a wireless LAN mobile station in which the value of a received signal strength indicator is measured, the measured received signal strength indicator value is compared with a threshold value serving as a criterion for executing the handover, and the handover is executed when the received signal strength indicator value is equal to or smaller than the threshold value, in which the wireless LAN mobile station includes a managing section that manages an unsatisfactory condition for the predetermined communication quality level and the value of a received signal strength indicator so that they are correlated with each other, the program causing a computer to perform a process including a communication quality level measuring operation of measuring a communication quality level of information which is transmitted or received between the wireless LAN mobile station and an association device associated with the wireless LAN mobile station; and a threshold value changing operation of, when the communication quality level measured by the communication quality level measuring operation corresponds to the unsatisfactory condition for the predetermined communication quality level, acquiring the received signal strength indicator value correlated with the unsatisfactory condition for the predetermined communication quality level, and changing the threshold value to the acquired received signal strength indicator value, wherein the managing section manages the unsatisfactory condition for the predetermined communication quality level so that a poorer unsatisfactory condition for the predetermined communication quality level is correlated with a higher received signal strength indicator value, and wherein, as the communication quality level measured in the communication quality level measuring operation corresponds to the poorer unsatisfactory condition for the predetermined communication quality level, the threshold value changing operation is configured to change the threshold value to a higher received signal strength indicator value.

The communication quality level measuring operation may allow the wireless LAN mobile station to measure the communication quality level by using at least one of an SNR measuring operation of measuring an SNR (signal to noise ratio); a BER measuring operation of measuring a BER (bit error rate); a PER measuring operation of measuring a PER (packet error rate); and a data retransmission rate measuring operation of measuring a data retransmission rate of information.

The threshold value changing operation may determine that the communication quality level is smaller than the predetermined communication quality level when the SNR measured in the SNR measuring operation is determined to be equal to or smaller than the predetermined threshold value, and the communication quality level is equal to or greater than the predetermined communication quality level when the SNR measured in the SNR measuring operation is determined to be greater than the predetermined threshold value; the communication quality level is smaller than the predetermined communication quality level when the BER measured in the BER measuring operation is determined to be equal to or smaller than the predetermined threshold value, and the communication quality level is equal to or greater than the predetermined communication quality level when the BER measured in the BER measuring operation is determined to be greater than the predetermined threshold value; the communication quality level is smaller than the predetermined communication quality level when the PER measured in the PER measuring operation is determined to be equal to or smaller than the predetermined threshold value, and the communication quality level is equal to or greater than the predetermined communication quality level when the PER measured in the PER measuring operation is determined to be greater than the predetermined threshold value; and the communication quality level is smaller than the predetermined communication quality level when the data retransmission rate measured in the data retransmission rate measuring operation is determined to be equal to or smaller than the predetermined threshold value, and the communication quality level is equal to or greater than the predetermined communication quality level when the data retransmission rate measured in the data retransmission rate measuring operation is determined to be greater than the predetermined threshold value.

The program may allow the wireless LAN mobile station to perform a process including a threshold value change determining operation of determining whether to change the threshold value in the threshold value changing operation.

The threshold value change determining operation may change the threshold value in the threshold value changing operation when a radio signal of which the received signal strength indicator value is greater than that of an associated device associated with the wireless LAN mobile station has been received by the wireless LAN mobile station.

As described above, the communication quality level of information transmitted and received between the wireless LAN mobile station and the association device associated with the wireless LAN mobile station is measured, and the threshold value serving as a criterion for executing the handover process is increased by a predetermined value when the measured communication quality level is smaller than a predetermined communication quality level. In this way, the threshold value is increased on the basis of other conditions in addition to a received signal strength indicator (RSSI), the execution of the handover process is facilitated, and the breaking of association with the current association device is expedited, thereby allowing the wireless LAN mobile station to make an association with an optimal association device.

In addition, the wireless LAN mobile station may include managing section that manages an unsatisfactory condition for the predetermined communication quality level and the value of a received signal strength indicator so that they are correlated with each other. The communication quality level of information transmitted and received between the wireless LAN mobile station and the association device associated with the wireless LAN mobile station is measured. When the measured communication quality level corresponds to the unsatisfactory condition for the predetermined communication quality level managed by the control unit, the RSSI correlated with the unsatisfactory condition for the predetermined communication quality level is acquired and the threshold value serving as the criterion for executing the handover process is changed to the acquired RSSI. The managing unit manages the unsatisfactory condition for the predetermined communication quality level so that a poorer unsatisfactory condition for the predetermined communication quality level is correlated with a higher RSSI. As the measured communication quality level corresponds to the poorer unsatisfactory condition for the predetermined communication quality level, the threshold value is changed to a higher RSSI. In this way, the threshold value serving as a criterion for executing a handover process is increased on the basis of other conditions in addition to a RSSI, the execution of the handover process is facilitated, and the breaking of association with the current association device is expedited, thereby allowing the wireless LAN mobile station to make an association with an optimal association device.

### BRIEF DESCRIPTION OF THE DRAWINGS

FIG. 1 is a schematic diagram showing a configuration of wireless LAN system;

FIG. 2 is a schematic diagram showing an example of a handover process;

FIG. 3 is a schematic diagram showing a series of operations performed in the process of the handover;

FIG. 4 is a block diagram showing an internal arrangement of wireless LAN base stations 10-1 to 10-N constituting a wireless LAN system;

FIG. 5 is a block diagram showing an internal arrangement of wireless LAN mobile station 1-1 to 1-N constituting the wireless LAN system;

FIG. 6 is a flowchart showing control operations performed in determining whether the communication quality level of the wireless LAN mobile station 1-1 to 1-N is smaller than a predetermined communication quality level;

FIG. 7 is a flowchart showing a first control operation performed by the wireless LAN mobile station 1-1 to 1-N;

FIG. 8 is a flowchart showing a second control operation performed by the wireless LAN mobile station 1-1 to 1-N;

FIG. 9 is a diagram showing the arrangement of a management table 208 in which a “unsatisfactory condition for the predetermined communication quality level” is correlated with “received signal strength (RSSI) value” serving as a criterion for executing the handover process;

FIG. 10 is a block diagram showing an internal arrangement of the wireless LAN mobile station 1-1 to 1-N constituting the wireless LAN system;

FIG. 11 is a flowchart showing control operations performed by the wireless LAN mobile station 1-1 to 1-N;

FIG. 12 is a block diagram showing an internal arrangement of the wireless LAN mobile station 1-1 to 1-N constituting the wireless LAN system in accordance with a modified example of the first embodiment of the invention, in which a data retransmission rate measuring unit 2064 is further included in the wireless LAN mobile station;

FIG. 13 is a flowchart showing control operations performed by the wireless LAN mobile station 1-1 to 1-N having the internal arrangement shown in FIG. 12; and

FIG. 14 is a block diagram showing an internal arrangement of the wireless LAN mobile station 1-1 to 1-N constituting the wireless LAN system in accordance with a modified example of the second embodiment of the invention, in which a data retransmission rate measuring unit 2064 is further included in the wireless LAN mobile station.

### DETAILED DESCRIPTION OF THE EXEMPLARY PREFERRED EMBODIMENTS

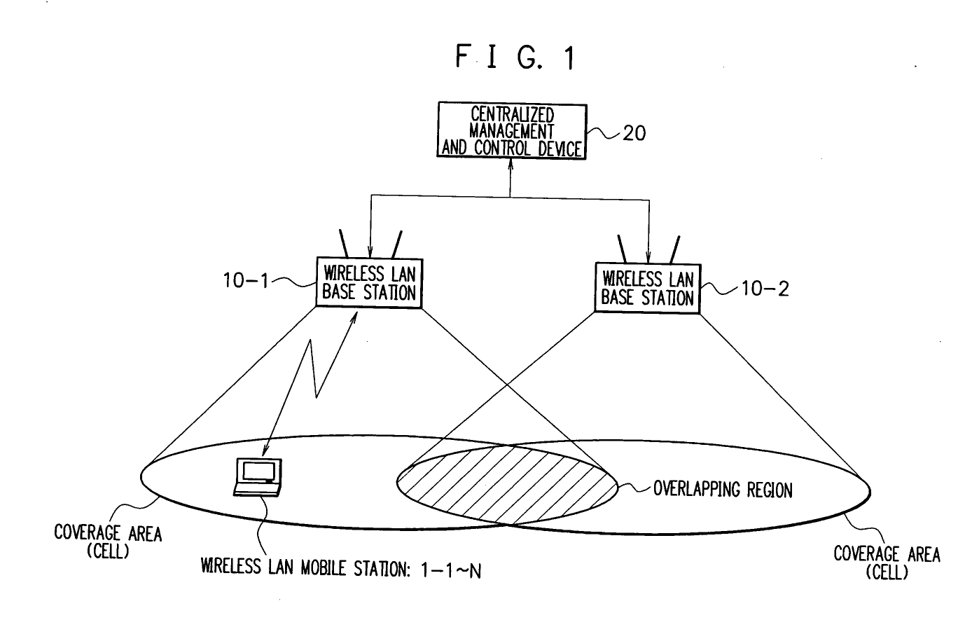

A wireless LAN system according to embodiments will be described with reference to FIG. 1.

The wireless LAN system includes a plurality of wireless LAN base stations 10-1 to 10-N (N is an arbitrary integer) and wireless LAN mobile stations 1-1 to 1-N (N is also arbitrary but not related to number of base stations) communicating with the wireless LAN base stations 10-1 to 10-N. The wireless LAN mobile stations 1-1 to 1-N perform a handover process when the value of a received signal strength indicator (RSSI) received from the wireless LAN base station 10-1 to 10-N associated with the wireless LAN mobile stations 1-1 to 1-N is equal to or smaller than a threshold value serving as a criterion for executing the handover process. The wireless LAN mobile stations 1-1 to 1-N control operations in such a manner that the communication quality level of information transmitted and received between a wireless LAN mobile station and the wireless LAN base stations 10-1 to 10-N is measured and the threshold value is increased by a predetermined value when the measured communication quality level is smaller than a predetermined communication quality level. In this way, the threshold value is increased on the basis of other conditions in addition to the RSSI, the execution of the handover process is facilitated, and the breaking of association with the currently associated device is expedited, thereby allowing the wireless LAN mobile station to make an association with the wireless LAN base stations 10-1 to 10-N, optimal association devices.

In addition, each of the wireless LAN mobile stations 1-1 to 1-N includes managing section that manages an unsatisfactory condition for the predetermined communication quality level and the value of the RSSI so that they are correlated with each other. A wireless LAN mobile station measures the communication quality level of information transmitted and received between the wireless LAN mobile station and the wireless LAN base stations 10-1 to 10-N (the association device associated with the wireless LAN mobile station). When the measured communication quality level corresponds to the unsatisfactory condition for the predetermined communication quality level managed by the managing section, the RSSI correlated with the unsatisfactory condition for the predetermined communication quality level is acquired and the threshold value is changed to the acquired RSSI. The managing section manages the unsatisfactory condition for the predetermined communication quality level so that a poorer unsatisfactory condition for the predetermined communication quality level is correlated with a higher RSSI. The wireless LAN mobile stations 1-1 to 1-N control operations in such a manner that as the measured communication quality level corresponds to the poorer unsatisfactory condition for the predetermined communication quality level, the threshold value is changed to a higher RSSI. In this way, the threshold value is increased on the basis of other conditions in addition to a RSSI, the execution of the handover process is facilitated, and the breaking of association with the currently associated device is expedited, thereby allowing a wireless LAN mobile station to establish communication with the wireless LAN base stations 10-1 to 10-N, optimal association devices. Hereinafter, the wireless LAN system will be described with reference to the accompanying drawings.

### First Embodiment

First, the arrangement of the wireless LAN system will be described with reference to FIG. 1.

As shown in FIG. 1, the wireless LAN system includes wireless LAN mobile stations 1-1 to 1-N (N is an arbitrary integer), a plurality of wireless LAN base stations 10-1 to 10-N, and a centralized management and control device 20.

<Centralized Management and Control Device 20>

The device 20 controls the entire operations of base stations 10-1 to 10-N and manages various settings of respective base stations 10-1 to 10-N.

<Wireless LAN base Stations 10-1 to 10-N>

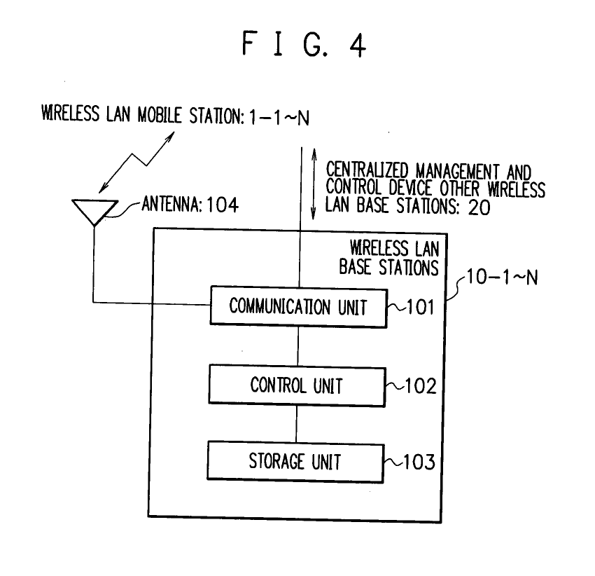

The base stations 10-1 to 10-N transmit and receive information to and from the mobile stations 1-1 to 1-N under the control of the device 20. Hereinafter, the internal arrangement of the wireless LAN base stations 10-1 to 10-N will be described with reference to FIG. 4.

As shown in FIG. 4, a base station includes a communication unit 101, a control unit 102, a storage unit 103, and an antenna 104.

The unit 101 transmits and receives information to and from the device 20 or establishes a radio link with the wireless LAN mobile station 1-1 to 1-N through the antenna 104, thereby transmitting and receiving the information at an arbitrary frequency. The unit 101 may transmit and receive the information to and from other wireless LAN base station. The unit 102 controls the entire operations of the wireless LAN base stations. The unit 103 stores various settings of the wireless LAN base stations or temporarily stores the information transmitted and received to and from the unit 101. An example of the various settings stored in the unit 103 may include a radio channel identifier and a service identifier (SSID: service set identifier).

<Wireless LAN Mobile Station 1-1 to 1-N>

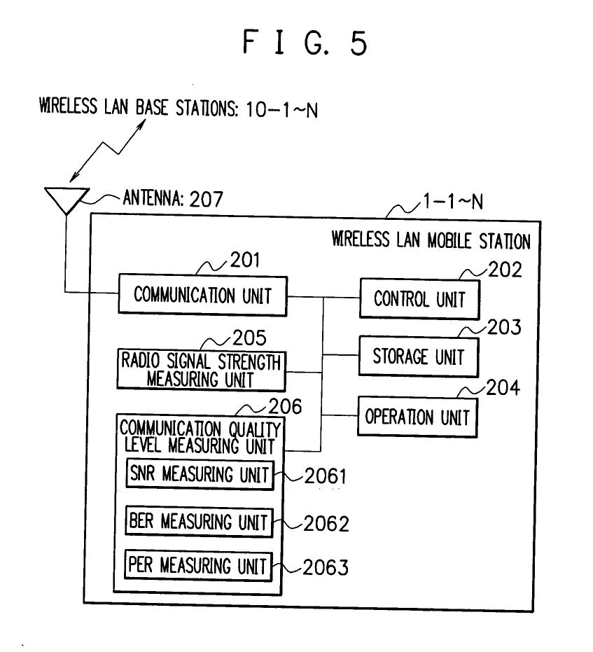

The wireless LAN mobile station 1-1 to 1-N transmits and receives information to and from the wireless LAN base stations 10-1 to 10-N. Hereinafter, the internal arrangement of the wireless LAN mobile station 1-1 to 1-N will be described with reference to FIG. 5.

As shown in FIG. 5, the wireless LAN mobile station 1-1 to 1-N includes a communication unit 201, a control unit 202, a storage unit 203, an operation unit 204, a radio signal strength measuring unit 205, a communication quality level measuring unit 206, and an antenna 207.

The unit 201 establishes a radio link with the wireless LAN base stations 10-1 to 10-N through the antenna 207, thereby transmitting and receiving the information at an arbitrary frequency. The unit 202 controls the entire operations of the wireless LAN mobile station.

The unit 203 stores various settings of a wireless LAN mobile station or temporarily stores the information transmitted and received to and from the unit 201. A threshold of the RSSI for determining whether to execute the handover process is also stored in the unit 203.

The unit 204 is used for inputting information for setting the various settings to be stored in the unit 203 or inputting information for controlling various operations of a wireless LAN mobile station.

The unit 205 measures the value of a RSSI of radio signals received by the unit 201.

The unit 206 measures the communication quality level of the information processed by the unit 201. As shown in FIG. 5, the unit 206 includes an SNR measuring unit 2061 for measuring an SNR (Signal to Noise Ratio), a BER measuring unit 2062 for measuring a BER (Bit Error Rate), and a PER measuring unit 2063 for measuring a PER (Packet Error Rate). Although, the unit 206 shown in FIG. 5 is configured to include three measuring units, that is, the SNR measuring unit 2061, the BER measuring unit 2062, and the PER measuring unit 2063, the unit 206 may include at least one of the SNR measuring unit 2061, the BER measuring unit 2062, and the PER measuring unit 2063. The unit 206 notifies the unit 202 of the measured communication quality level, and the unit 202 determines whether the communication quality level of the wireless LAN mobile station 1-1 to 1-N is smaller than a predetermined communication quality level, on the basis of the communication quality level acquired from the unit 206.

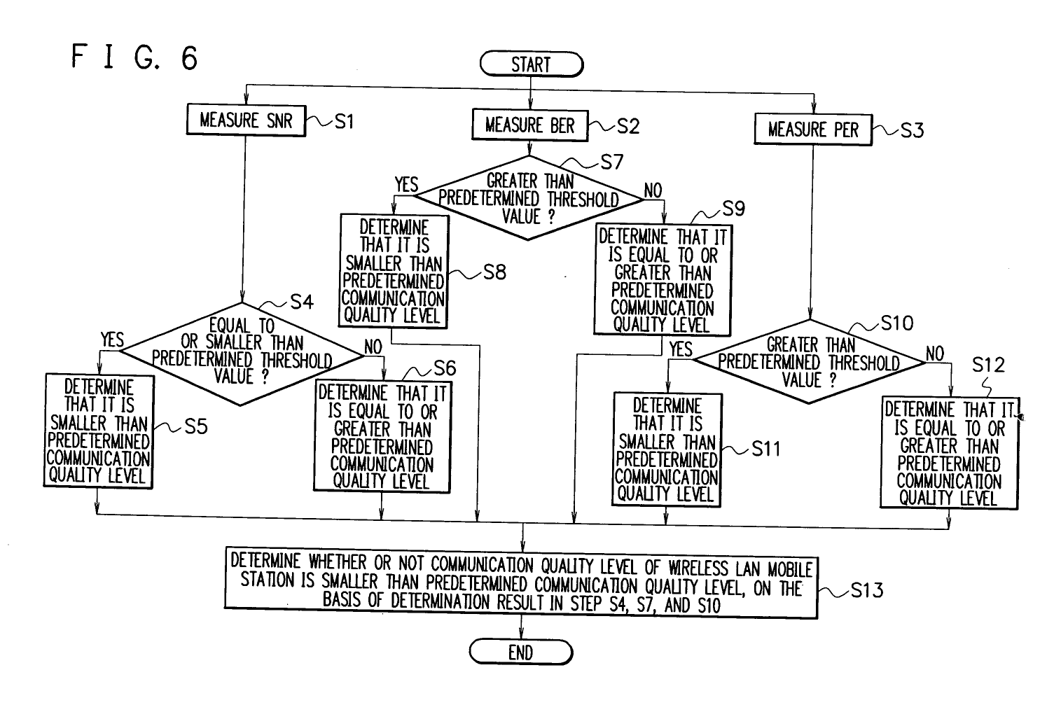

Next, control operations performed by the unit 202 for determining whether the communication quality level of the wireless LAN mobile station 1-1 to 1-N is smaller than the predetermined communication quality level, on the basis of the communication quality level acquired from the unit 206 will be described with reference to FIGS. 5 and 6.

First, the SNR measuring unit 2061 measures the SNR in the unit 201 (step S1), the BER measuring unit 2062 measures the BER in the unit 201 (step S2), and the PER measuring unit 2063 measures the PER in the unit 201 (step S3). The measurement results in the SNR measuring unit 2061, the BER measuring unit 2062, and the PER measuring unit 2063 are provided to the unit 202.

The unit 202 determines whether the communication quality level of the wireless LAN mobile station 1-1 to 1-N is smaller than the predetermined communication quality level, based on the measurement result acquired from the SNR measuring unit 2061, the BER measuring unit 2062, and the PER measuring unit 2063. When the unit 202 determines that the SNR measured by the unit 2061 is equal to or smaller than the predetermined threshold value (step S4: Yes), the unit 202 determines that the communication quality level of the wireless LAN mobile station 1-1 to 1-N is smaller than the predetermined communication quality level (step S5). On the other hand, when the unit 202 determines that the SNR measured by the unit 2061 is greater than the predetermined threshold value (step S4: No), the unit 202 determines that the communication quality level of the wireless LAN mobile station 1-1 to 1-N is equal to or greater than the predetermined communication quality level (step S6).

When the unit 202 determines that the BER measured by the unit 2062 is greater than the predetermined threshold value (step S7: Yes), the unit 202 determines that the communication quality level of the wireless LAN mobile station 1-1 to 1-N is smaller than the predetermined communication quality level (step S8). On the other hand, when the unit 202 determines that the BER measured by the unit 2062 is equal to or smaller than the predetermined threshold value (step S7: No), the unit 202 determines that the communication quality level of the wireless LAN mobile station 1-1 to 1-N is equal to or greater than the predetermined communication quality level (step S9).

When the unit 202 determines that the PER measured by the unit 2063 is greater than the predetermined threshold value (step S10: Yes), the unit 202 determines that the communication quality level of the wireless LAN mobile station 1-1 to 1-N is smaller than the predetermined communication quality level (step S11). On the other hand, when the unit 202 determines that the PER measured by the unit 2063 is equal to or smaller than the predetermined threshold value (step S10: No), the unit 202 determines that the communication quality level of the wireless LAN mobile station 1-1 to 1-N is equal to or greater than the predetermined communication quality level (step S112).

Then, the unit 202 determines whether the communication quality level of the wireless LAN mobile station 1-1 to 1-N is smaller than the predetermined communication quality level, on the basis of the determination results in steps S4, S7, and S10, which are made on the basis of the measurement results in the units 2061, 2062 and 2063 (step S113).

For example, when even one determination result among the three determination results in steps S4, S7, and S10 is smaller than the predetermined communication quality level, the communication quality level of the wireless LAN mobile station 1-1 to 1-N is judged to be smaller than the predetermined communication quality level. Or, when all of the three determination results in steps S4, S7, and S110 are smaller than the predetermined communication quality level, it is determined that the communication quality level of the wireless LAN mobile station 1-1 to 1-N is smaller than the predetermined communication quality level.

The determination condition used for determining whether the wireless LAN mobile station is smaller than the predetermined communication quality level, on the basis of the three determination results in steps S4, S7, and S10, may be suitably modified through an operation of the operation unit 204. As long as it is determined whether communication quality of a mobile station is smaller than the predetermined communication quality level, on the basis of the three determination results in steps S4, S7, and S10, various determination conditions may be suitably combined to be used as a determination condition for determining whether the communication quality level is smaller than the predetermined communication quality level.

In FIG. 6, the determination on whether the communication quality level of the wireless LAN mobile station 1-1 to 1-N is smaller than the predetermined communication quality level is made on the basis of the three determination results in the units 2061, 2062 and 2063. However, the determination on whether the communication quality level of the wireless LAN mobile station 1-1 to 1-N is smaller than the predetermined communication quality level may be made on the basis of at least one of the determination results in the units 2061, 2062 and 2063.

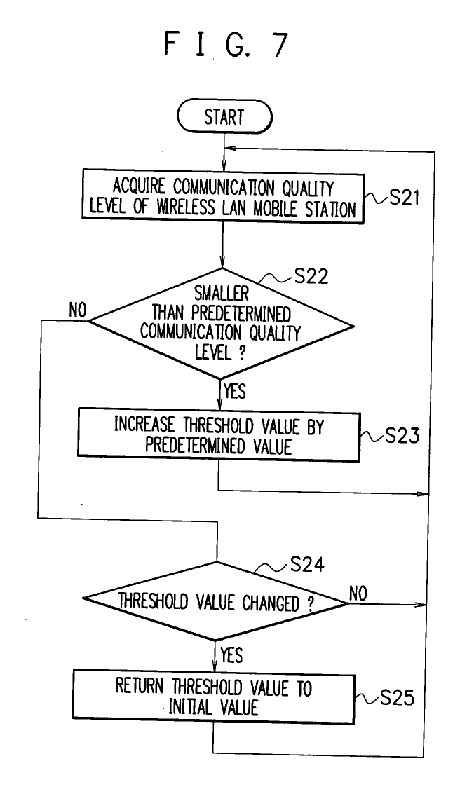

Next, control operations performed by the wireless LAN mobile station 1-1 to 1-N will be described with reference to FIG. 7. FIG. 7 is a diagram showing control operations performed at the time of changing the threshold value on the basis of the communication quality level measured by the unit 206.

First, the unit 206 measures the communication quality level of information processed by the unit 201 and notifies the measured communication quality level to the unit 202.

The unit 202 receives the communication quality level in the unit 201 from the unit 206 and thus acquires the communication quality level of the wireless LAN mobile station 1-1 to 1-N (step S21). Then, the unit 202 determines whether the acquired communication quality level is smaller than the predetermined communication quality level (step S22). When it is determined that the communication quality level of the wireless LAN mobile station 1-1 to 1-N is smaller than the predetermined communication quality level (step S22: Yes), the unit 202 increases the threshold value stored in the storage unit, by a predetermined value and stores the increased threshold value to the unit 203 as a new threshold value serving as the criterion for executing the handover process (step S23).

The unit 202 repeats the above-described operations of steps S21 to S23 until it is determined that the communication quality level of the wireless LAN mobile station 1-1 to 1-N is equal to or greater than the predetermined communication quality level, while gradually increasing the threshold value serving as the criterion for executing the handover process by a predetermined value. Accordingly, it is possible to facilitate the execution of the handover process and expedite the breaking of association with the wireless LAN base station currently associated with the wireless LAN mobile station 1-1 to 1-N, thereby allowing the wireless LAN mobile station to perform an operation of scanning other optimal wireless LAN base station.

When the unit 202 acquires the communication quality level of the wireless LAN mobile station 1-1 to 1-N (step S21) and it is determined that the acquired communication quality level is not smaller than the predetermined communication quality level (step S22: No), the unit 202 determines whether the threshold value is changed (step S24). When it is determined that the threshold value is changed (step S24: Yes), the unit 202 returns the changed threshold value to an initial threshold value (initial value) (step S25). In this way, it is possible to return the threshold value stored in the unit 203 into the initial value. When it is determined in step S24 that the threshold value has not been changed (step S24: No), an operation of step S21 is performed with the threshold value unchanged.

In the control operations shown in FIG. 7, a sequence of operations (step S21→step S22, No→step S24, No) is repeated when the communication quality level between the wireless LAN mobile station 1-1 to 1-N and the wireless LAN base stations 10-1 to 10-N currently communicating with the wireless LAN mobile station is maintained at a level equal to or greater than the predetermined communication quality level.

When the communication quality level between the wireless LAN mobile station 1-1 to 1-N and the wireless LAN base stations 10-1 to 10-N currently communicating with the wireless LAN mobile station decreases to a level smaller than the predetermined quality level and the handover process is to be executed, a sequence of operations (step S21→step S22, Yes→step S23) is repeated until the handover process is executed. After the handover process is executed, it is determined in step S22 that the communication quality level is equal to or greater than the predetermined quality level (step S22, No), and the threshold value is returned to the initial value in step S25.

When the communication quality level between the wireless LAN mobile station 1-1 to 1-N and the wireless LAN base stations 10-1 to 10-N currently communicating with the wireless LAN mobile station decreases to a level smaller than the predetermined quality level, the handover process is not executed, and the communication quality level increased to a level equal to or greater than the predetermined quality level, a sequence of operations (step S21→step S22, Yes→step S23) is repeated. Then, it is determined in step S22 that the communication quality level is equal to or greater than the predetermined quality level (step S22, No), and the threshold value is returned to the initial value in step S25.

As described above, the wireless LAN system is configured to gradually increase the threshold value serving as a criterion for executing the handover by a predetermined value when the wireless LAN mobile station 1-1 to 1-N determines that the communication quality level of the wireless LAN mobile station 1-1 to 1-N measured by the unit 206 is smaller than the predetermined quality level. Accordingly, it is possible to facilitate the execution of the handover process and expedite the breaking of association with the currently associated wireless LAN base station, thereby allowing the wireless LAN mobile station to make an association with other optimal wireless LAN base stations.

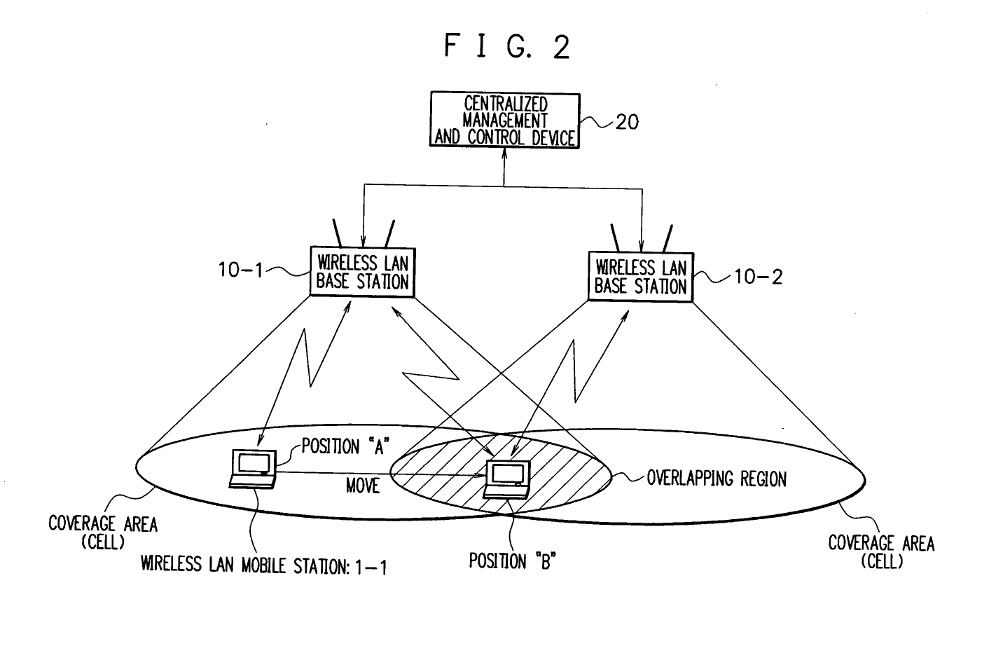

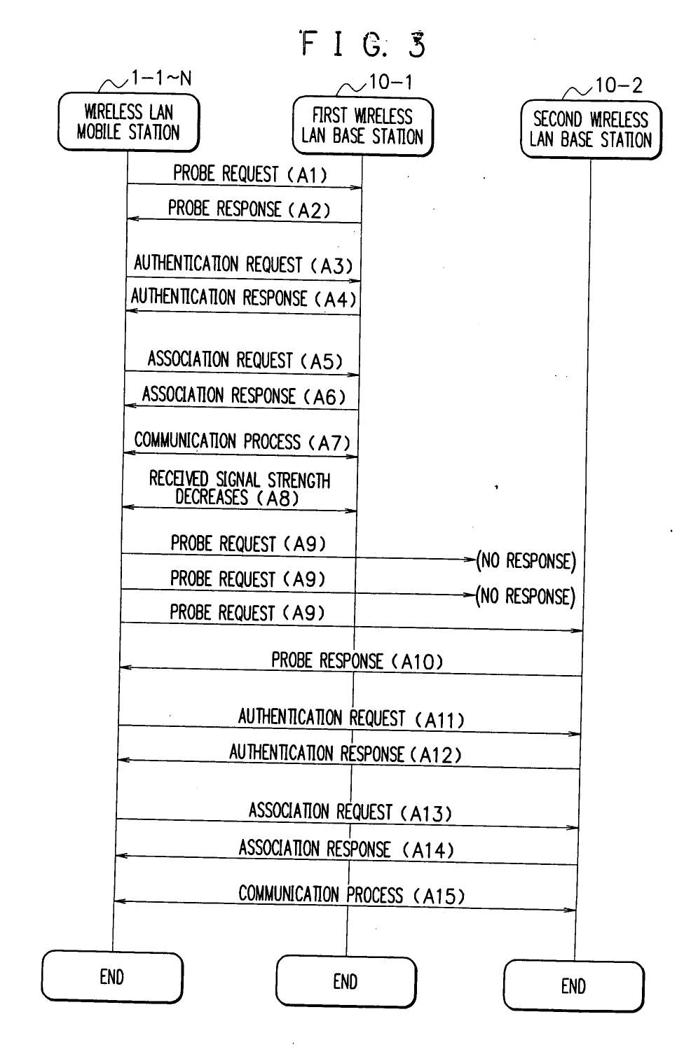

Conventionally, as shown in FIG. 2, even when the wireless LAN mobile station 1-1 moved from the position “A” to the position “B” where the wireless LAN mobile station 1-1 made an association with the optimal second wireless LAN base station 10-2 providing a stronger RSSI value than that of the first wireless LAN base station 10-1 currently communicating with the wireless LAN mobile station 1-1, the wireless LAN mobile station 1-1 could not execute the handover process unless the value of a RSSI of radio signals received from the first wireless LAN base station 10-1 was equal to or smaller than the threshold value. Therefore, even when the wireless LAN mobile station 1-1 moves to the position “B”, the wireless LAN mobile station 1-1 could not make an association with the optimal second wireless LAN base station 10-2 providing a stronger RSSI which allows a better communication quality than the first wireless LAN base station 10-1.

In contrast, according to the present embodiments, the communication quality level of information transmitted and received to and from the first wireless LAN base station 10-1 currently communicating with the wireless LAN mobile station 1-1 is measured, and the threshold value is gradually increased by a predetermined value when it is determined that the measured communication quality level is smaller than the predetermined communication quality level. Therefore, when the wireless LAN mobile station 1-1 moves from the position “A” to the position “B” and the communication quality level between the wireless LAN mobile station 1-1 and the first wireless LAN base station 10-1 currently communicating with a region corresponding to the position “B” deteriorates, it is possible to facilitate the execution of the handover process. Accordingly, it is possible to break the association sooner with the wireless LAN base station 10-1 providing the deteriorated communication quality level and to allow the wireless LAN mobile station to make an association with the second wireless LAN base station 10-2 providing a better communication quality level than the first wireless LAN base station 10-1. In addition, since the execution of the handover process is facilitated by gradually increasing the threshold value on the basis of the communication quality level in addition to the RSSI, it is possible to execute the handover process at a suitable time and allow the wireless LAN mobile station to make an association with the second wireless LAN base station 10-2 while breaking the association with the first wireless LAN base station 10-1.

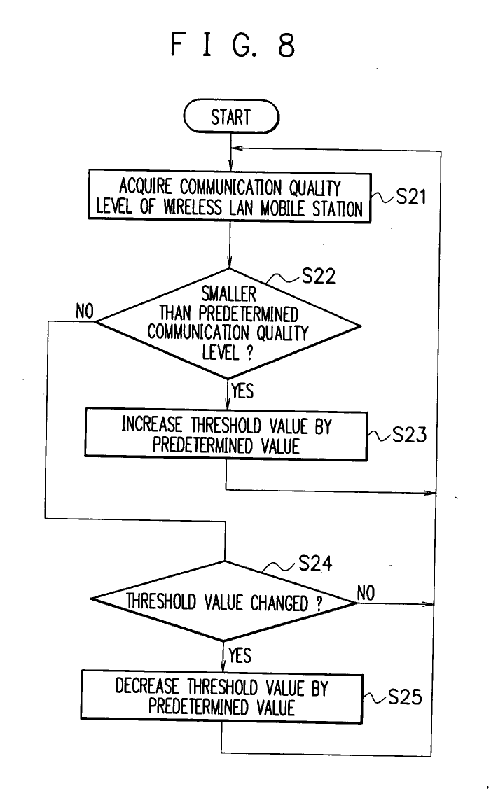

In the above-described operations shown in FIG. 7, when it is determined at step S22 that the communication quality level measured by the unit 206 is smaller than the predetermined communication quality level (step S22: Yes), the threshold value is increased by a predetermined value at step S23, and the operation of step S22 is performed. When it is determined in step S22 that the communication quality level measured by the unit 206 is equal to or greater than the predetermined communication quality level (step S22, No), the threshold value is returned to the initial value at step S25. The process operations shown in FIG. 7 may be modified in the following manner. As shown in FIG. 8, when it is determined at step S22 that the communication quality level measured by the unit 206 is smaller than the predetermined communication quality level (step S22: Yes), the threshold value is increased by a predetermined value at step S23, and the operation of step S22 is performed. When it is determined at step S22 that the communication quality level measured by the unit 206 is equal to or greater than the predetermined communication quality level (step S22: No), the threshold value is decreased by a predetermined value in step S25. When it is determined in step S22 that the communication quality level measured by the unit 206 is maintained at a level equal to or greater than the predetermined communication quality level (step S22, No), the threshold value is gradually decreased by the predetermined value in step S25 and finally returned to the initial value. In this way, unlike in FIG. 7, in which the threshold value is returned to the initial value in step S25 when it is determined that the communication quality level is equal to or greater than the predetermined quality level (step S22: No) and the threshold value is changed (step S24: Yes), the threshold value is gradually decreased by the predetermined value at step S25 and finally returned to the initial value through a plurality of operations when it is determined that the communication quality level is equal to or greater than the predetermined quality level (step S22, No) and the threshold value is changed (step S24: Yes), as shown in FIG. 8. Accordingly, it is possible to decrease the number of operations in step S23 which are performed to facilitate the execution of the handover process when it is determined that the communication quality level is smaller than the predetermined communication quality level (step S22: Yes), compared with the process operations shown in FIG. 7.

Although the above-described series of process operations shown in FIGS. 6 to 8 are performed by the wireless LAN mobile station 1-1 to 1-N shown in FIG. 5, the hardware configuration of the wireless LAN mobile station 1-1 to 1-N is not particularly limited as long as the series of process operations shown in FIGS. 6 to 8 are performed. In addition, the determination of whether to perform the series of process operations shown in FIGS. 7 and 8 may be made through an operation of the unit 204. Accordingly, it is possible to allow user to suitably determine whether to perform the series of process operations shown in FIGS. 7 and 8.

In addition, it is possible to allow the wireless LAN mobile station 1-1 to perform the series of process operations shown in FIGS. 7 and 8 when the wireless LAN mobile station 1-1 moves to the position “B” and determines that it has received radio signals having a greater RSSI value than that from the first wireless LAN base station 10-1 currently associated with the wireless LAN mobile station 1-1, as shown in FIG. 2. Accordingly, it is possible to execute the handover process at a suitable time when it is determined that the communication quality level of information transmitted and received to and from the first wireless LAN base station 10-1 currently associated with the wireless LAN mobile station 1-1 is smaller than the predetermined communication quality level, thereby allowing the wireless LAN mobile station to make an association with the second wireless LAN base station 10-2 while breaking the association with the first wireless LAN base station 10-1.

### Second Embodiment

Next, a second embodiment of the invention will be described.

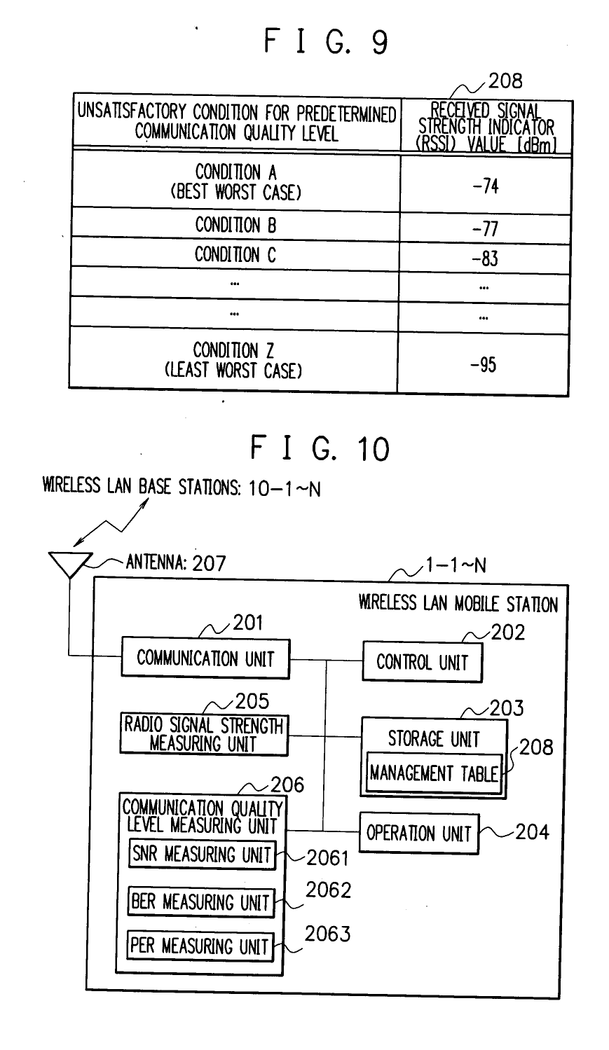

In the wireless LAN system according to the second embodiment, as shown in FIG. 9, the wireless LAN mobile station 1-1 to 1-N includes a management table 208 in which a “unsatisfactory condition for the predetermined communication quality level” is correlated with “received signal strength indicator (RSSI) value” serving as a criterion for executing the handover process. The wireless LAN mobile station 1-1 to 1-N changes the threshold value serving as the criterion for executing the handover process on the basis of information stored in the table 208.

The table 208 manages the unsatisfactory condition for the predetermined communication quality level so that a poorer unsatisfactory condition for the predetermined communication quality level is correlated with a higher RSSI value. When the wireless LAN mobile station 1-1 to 1-N determines that the communication quality level measured by the communication quality level measuring unit 206 corresponds to “the unsatisfactory condition for the predetermined communication quality level” managed by the table 208, on the basis of the communication quality level of the wireless LAN mobile station measured by the unit 206 and the information stored in the table 208 shown in FIG. 9, the wireless LAN mobile station 1-1 to 1-N acquires “the RSSI value” correlated with “the unsatisfactory condition for the predetermined communication quality level,” changes the threshold value to the acquired RSSI value, and stores the changed threshold value in the unit 203 as the communication quality level measured by the unit 206 corresponds to the poorer unsatisfactory condition for the predetermined communication quality level, the threshold value is changed to a higher RSSI value. Accordingly, the threshold value is increased on the basis of other conditions in addition to the RSSI so as to facilitate the execution of the handover process and expedite the breaking of association with the wireless LAN base station 10-1 to 10-N serving as the current association device, thereby allowing the wireless LAN mobile station to make an association with other wireless LAN base stations 10-1 to 10-N serving as an optimal association device. Hereinafter, the wireless LAN system according to the second embodiment will be described with reference to FIGS. 9 and 10. The wireless LAN system of the second embodiment may have the same configuration as that of the wireless LAN system of the first embodiment shown in FIG. 1.

First, the internal arrangement of the wireless LAN mobile station 1-1 to 1-N constituting the wireless LAN system according to the second embodiment will be described with reference to FIG. 10.

As shown in FIG. 10, the wireless LAN mobile station 1-1 to 1-N includes a communication unit 201, a control unit 202, a storage unit 203, an operation unit 204, a radio signal strength measuring unit 205, a communication quality level measuring unit 206, and an antenna 207. The management table 208 shown in FIG. 9 is stored in the unit 203. Each component of the wireless LAN mobile station 1-1 to 1-N of the second embodiment has the same function as that of the wireless LAN mobile station 1-1 to 1-N of the first embodiment.

The table 208 shown in FIG. 9 constructs the “unsatisfactory condition for the predetermined communication quality level” by suitably combining the three measurement results in the SNR measuring unit 2061, the BER measuring unit 2062, and the PER measuring unit 2063, all of which constitutes the unit 206, and manages the “unsatisfactory condition for the predetermined communication quality level” so that the “unsatisfactory condition for the predetermined communication quality level” is correlated with the “RSSI value.” The table 208 manages the “unsatisfactory condition for the predetermined communication quality level” so that a poorer “unsatisfactory condition for the predetermined communication quality level” is correlated with a higher “RSSI value.”

For example, the table 208 manages the “unsatisfactory condition for the predetermined communication quality level” so that the “unsatisfactory condition for the predetermined communication quality level” is correlated with a lower “RSSI value” when only one of the three measurement results in the units 2061, 2062, and 2063 is smaller than the predetermined communication quality level.

Moreover, the table 208 manages the “unsatisfactory condition for the predetermined communication quality level” so that the “unsatisfactory condition for the predetermined communication quality level” is correlated with an intermediate “RSSI value” when two of the three measurement results in the units 2061, 2062, and 2063 are smaller than the predetermined communication quality level.

Furthermore, the table 208 manages the “unsatisfactory condition for the predetermined communication quality level” so that the “unsatisfactory condition for the predetermined communication quality level” is correlated with a higher “RSSI value” when all of the three measurement results in the units 2061, 2062, and 2063 is smaller than the predetermined communication quality level.

In this way, the table 208 can manage the “unsatisfactory condition for the predetermined communication quality level” so that a poorer “unsatisfactory condition for the predetermined communication quality level” is correlated with a higher “RSSI value.”

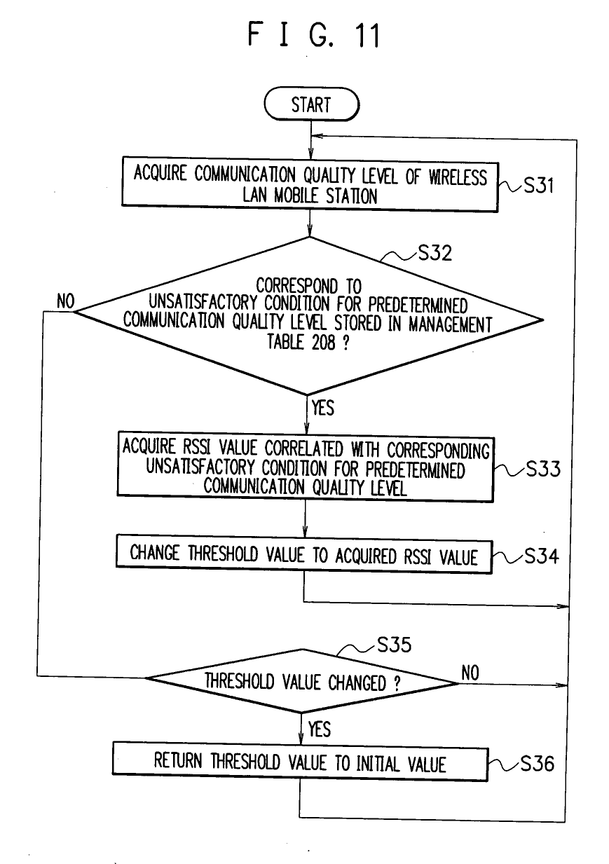

Next, control operations performed by the wireless LAN mobile station 1-1 to 1-N will be described with reference to FIG. 11. FIG. 11 is a diagram showing control operations performed at the time of changing the threshold value on the basis of the communication quality level measured by the unit 206.

First, the unit 206 measures the communication quality level of information processed by the unit 201 and notifies the unit 202 of the measured communication quality level.

The unit 202 receives the communication quality level in the unit 201 from the unit 206 and thus acquires the communication quality level of the wireless LAN mobile station 1-1 to 1-N (step S31).

Then, the unit 202 determines whether the communication quality level of the wireless LAN mobile station 1-1 to 1-N corresponds to the “unsatisfactory condition for the predetermined communication quality level” managed by the table 208, on the basis of the communication quality level of the wireless LAN mobile station 1-1 to 1-N acquired from the unit 206 and the information stored in the table 208 stored in the unit 203 (step S32).

When the unit 202 determines that the communication quality level of the wireless LAN mobile station 1-1 to 1-N corresponds to the “unsatisfactory condition for the predetermined communication quality level” managed by the table 208 (step S32: Yes), the unit 202 acquires the “RSSI value” correlated with the “unsatisfactory condition for the predetermined communication quality level” (step S33), changes the threshold value to the acquired “RSSI value,” and stores the changed threshold value in the unit 203 (step S34).

The unit 202 repeats the above-described operations (steps S31 to S34) until it is determined in step S32 that the communication quality level of the wireless LAN mobile station 1-1 to 1-N does not corresponds to the “unsatisfactory condition for the predetermined communication quality level” managed by the table 208. As the communication quality level of the wireless LAN mobile station 1-1 to 1-N corresponds to the poorer “unsatisfactory condition for the predetermined communication quality level” managed by the table 208, the unit 202 acquires the higher “RSSI value” from the table 208 and changes the threshold value to the higher “RSSI value.” In this way, the threshold value is increased on the basis of other conditions in addition to the RSSI so as to facilitate the execution of the handover process and expedite the breaking of association with the wireless LAN base station 10-1 to 10-N serving as the current association device, thereby allowing the wireless LAN mobile station to make an association with other wireless LAN base stations 10-1 to 10-N serving as an optimal association device.

When the unit 202 acquires the communication quality level of the wireless LAN mobile station 1-1 to 1-N (step S31) and it is determined that the acquired communication quality level of the wireless LAN mobile station 1-1 to 1-N does not correspond to the “unsatisfactory condition for the predetermined communication quality level” managed by the table 208 (step S32: No), the unit 202 determines whether the threshold value is changed (step S35). When it is determined that the threshold value is changed (step S35: Yes), the unit 202 returns the changed threshold value to an initial threshold value (initial value) (step S36). In this way, it is possible to return the threshold value stored in the unit 203 into the initial value. When it is determined in step S35 that the threshold value has not been changed (step S35: No), an operation of step S31 is performed with the threshold value unchanged.

As described above, according to the present embodiment, the wireless LAN mobile station 1-1 to 1-N includes the table 208 in which the “unsatisfactory condition for the predetermined communication quality level” is correlated with the “RSSI value.” The wireless LAN mobile station 1-1 to 1-N measures the communication quality of information transmitted and received to and from the wireless LAN base station 10-1 to 10-N serving as the association device associated with the wireless LAN mobile station 1-1 to 1-N. When it is determined that the measured communication quality level corresponds to the “unsatisfactory condition for the predetermined communication quality level” managed by the table 208, the wireless LAN mobile station 1-1 to 1-N acquires the “RSSI value” correlated with the “unsatisfactory condition for the predetermined communication quality level” and change the threshold value serving as the criterion for executing the handover process to the acquired “RSSI value.”

In addition, according to the present embodiment, the table 208 is configured to manage the “unsatisfactory condition for the predetermined communication quality level” so that a poorer “unsatisfactory condition for the predetermined communication quality level” is correlated with a higher “RSSI value.” As the measured communication quality level corresponds to the poorer “unsatisfactory condition for the predetermined communication quality level,” the wireless LAN mobile station 1-1 to 1-N acquires the higher “RSSI value” from the table 208 and changes the threshold value to the higher “RSSI value,” and stores the changed threshold value in the unit 203. Accordingly, the threshold value is increased on the basis of other conditions in addition to the RSSI so as to facilitate the execution of the handover process and expedite the breaking of association with the wireless LAN base station 10-1 to 10-N serving as the current association device, thereby allowing the wireless LAN mobile station to make an association with other wireless LAN base stations 10-1 to 10-N serving as an optimal association device.

Although the above-described series of operations shown in FIG. 11 are performed by the wireless LAN mobile station 1-1 to 1-N shown in FIG. 10, the hardware configuration of the wireless LAN mobile station 1-1 to 1-N is not particularly limited as long as the series of process operations shown in FIG. 11 is performed. In addition, the determination of whether to perform the series of process operations shown in FIG. 11 may be made through an operation of the operation unit 204. Accordingly, it is possible to allow user to suitably determine whether to perform the series of process operations shown in FIG. 11.

In addition, it is possible to allow the wireless LAN mobile station 1-1 to perform the series of process operations shown in FIG. 11 when the wireless LAN mobile station 1-1 moves to the position “B” and determines that it has received radio signals having a greater RSSI value than that received from the first wireless LAN base station 10-1 currently associated with the wireless LAN mobile station 1-1, as shown in FIG. 2. Accordingly, it is possible to execute the handover process at a suitable time when it is determined that the communication quality level of information transmitted and received to and from the first wireless LAN base station 10-1 currently associated with the wireless LAN mobile station 1-1 is smaller than the predetermined communication quality level, thereby allowing the wireless LAN mobile station to make an association with the second wireless LAN base station 10-2 while breaking the association with the first wireless LAN base station 10-1.

While it has been described with reference to exemplary embodiments, various changes may be made therein without departing from the spirit of the invention.

For example, in the above-described embodiments, the communication quality level of the wireless LAN mobile station 1-1 to 1-N is measured by at least one of the SNR measuring unit 2601, the BER measuring unit 2602, and the PER measuring unit 2603. However, any quality information items may be measured and used as the communication quality information of the wireless LAN mobile station 1-1 to 1-N as long as the quality information items are useful for high-quality communication between the wireless LAN mobile station 1-1 to 1-N and the wireless LAN base stations 10-1 to 10-N.

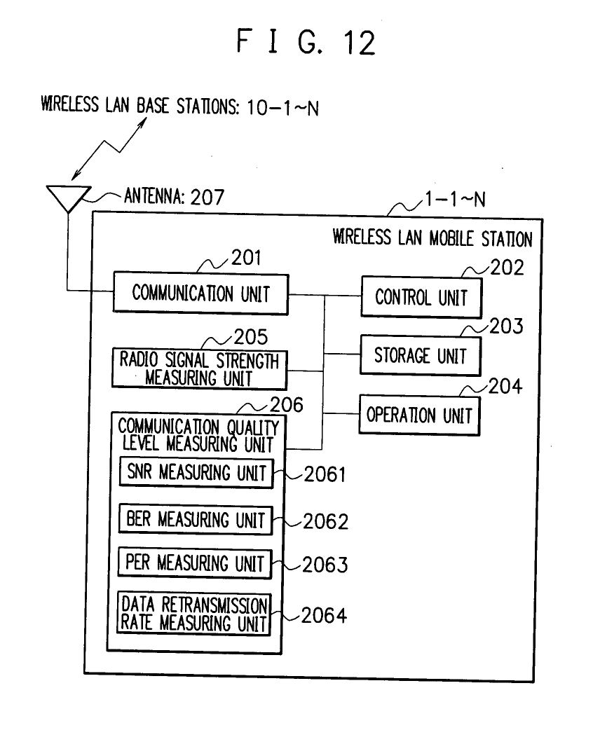

For example, as shown in FIG. 12, a data retransmission rate measuring unit 2064 for measuring a data retransmission rate of information transmitted and received to and from the wireless LAN base stations 10-1 to 10-N currently associated with the wireless LAN mobile station 1-1 to 1-N may be further provided. In this case, the communication quality level of the wireless LAN mobile station 1-1 to 1-N may be measured on the basis of at least one of the measurement results in the SNR measuring unit 2601, the BER measuring unit 2602, the PER measuring unit 2603, and the data retransmission rate measuring unit 2064.

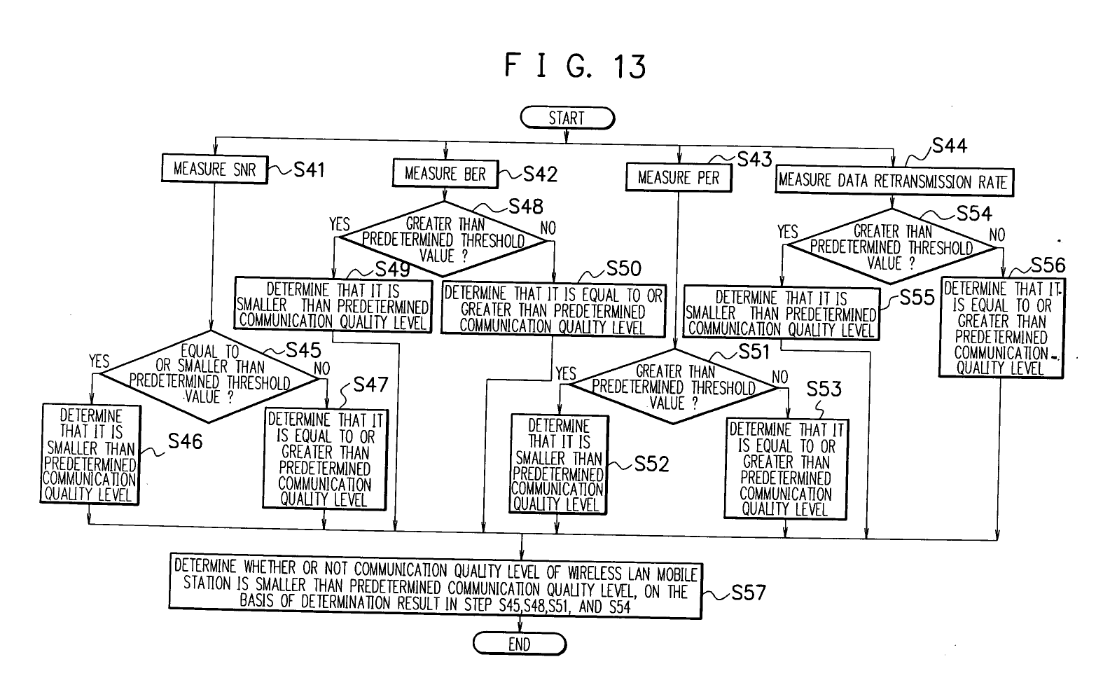

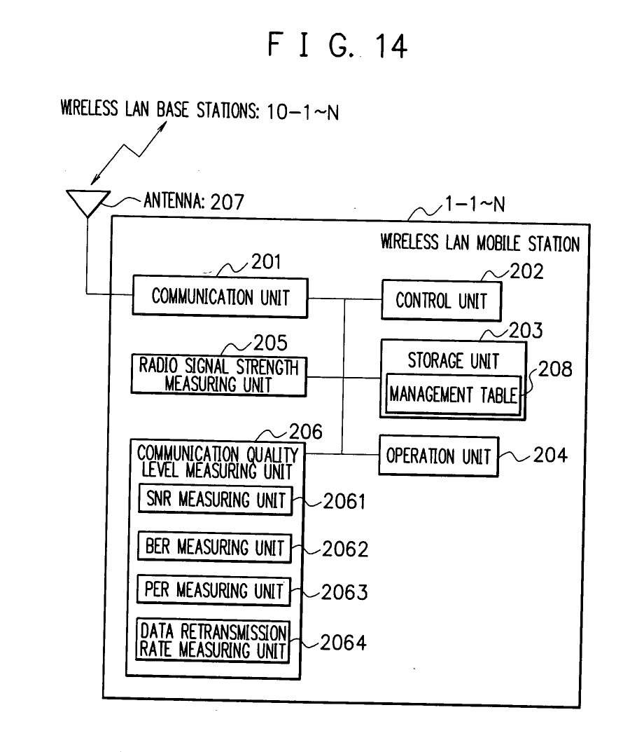

When provided with the unit 2064 as shown in FIG. 12, the wireless LAN mobile station 1-1 to 1-N of the first embodiment performs the control operations shown in FIG. 13 so as to determine whether the communication quality level of the wireless LAN mobile station 1-1 to 1-N is smaller than the predetermined communication quality level, on the basis of the communication quality level acquired from the unit 206. Hereinafter, control operations for determining whether the communication quality level of the wireless LAN mobile station 1-1 to 1-N is smaller than the predetermined communication quality level, on the basis of the communication quality level acquired from the unit 206 will be described with reference to FIG. 13

First, the SNR measuring unit 2061 measures the SNR in the unit 201 (step S41), the BER measuring unit 2062 measures the BER in the unit 201 (step S42), the PER measuring unit 2063 measures the PER in the unit 201 (step S43), and the data retransmission rate measuring unit 2064 measures the data retransmission rate of information transmitted and received to and from the wireless LAN base stations 10-1 to 10-N currently associated with the wireless LAN mobile station 1-1 to 1-N (step S44).

The measurement results in the units 2061, 2062, 2063, and 2064 are sent to the unit 202.

The unit 202 determines whether the communication quality level of the wireless LAN mobile station 1-1 to 1-N is smaller than the predetermined communication quality level, on the basis of the measurement result acquired from the units 2061, 2062, 2063, and 2064. When the unit 202 determines that the SNR measured by the unit 2061 is equal to or smaller than the predetermined threshold value (step S45: Yes), the unit 202 determines that the communication quality level of the wireless LAN mobile station 1-1 to 1-N is smaller than the predetermined communication quality level (step S46). On the other hand, when the unit 202 determines that the SNR measured by the unit 2061 is greater than the predetermined threshold value (step S45, No), the unit 202 determines that the communication quality level of the wireless LAN mobile station 1-1 to 1-N is equal to or greater than the predetermined communication quality level (step S47).

When the unit 202 determines that the BER measured by the unit 2062 is greater than the predetermined threshold value (step S48: Yes), the unit 202 determines that the communication quality level of the wireless LAN mobile station 1-1 to 1-N is smaller than the predetermined communication quality level (step S49). On the other hand, when the unit 202 determines that the BER measured by the unit 2062 is equal to or smaller than the predetermined threshold value (step S48: No), the unit 202 determines that the communication quality level of the wireless LAN mobile station 1-1 to 1-N is equal to or greater than the predetermined communication quality level (step S50).

When the unit 202 determines that the PER measured by the unit 2063 is greater than the predetermined threshold value (step S51: Yes), the unit 202 determines that the communication quality level of the wireless LAN mobile station 1-1 to 1-N is smaller than the predetermined communication quality level (step S52). On the other hand, when the unit 202 determines that the PER measured by the unit 2063 is equal to or smaller than the predetermined threshold value (step S51: No), the unit 202 determines that the communication quality level of the wireless LAN mobile station 1-1 to 1-N is equal to or greater than the predetermined communication quality level (step S53).

When the unit 202 determines that the data retransmission rate measured by the unit 2064 is greater than the predetermined threshold value (step S54: Yes), the unit 202 determines that the communication quality level of the wireless LAN mobile station 1-1 to 1-N is smaller than the predetermined communication quality level (step S55). On the other hand, when the unit 202 determines that the data retransmission rate measured by the unit 2064 is equal to or smaller than the predetermined threshold value (step S51: No), the unit 202 determines that the communication quality level of the wireless LAN mobile station 1-1 to 1-N is equal to or greater than the predetermined communication quality level (step S56).

Then, the unit 202 determines whether the communication quality level of the wireless LAN mobile station 1-1 to 1-N is smaller than the predetermined communication quality level, on the basis of the determination results in steps S45, S48, S51, and S54, which are made on the basis of the measurement results in the units 2061, 2062, 2063, and unit 2064 (step S57).

For example, when it is determined that one determination result of the four determination results in steps S45, S48, S51, and S54 is smaller than the predetermined communication quality level, it is determined that the communication quality level of the wireless LAN mobile station 1-1 to 1-N is smaller than the predetermined communication quality level. Or, when it is determined that all of the four determination results in steps S45, S48, S51, and S54 are smaller than the predetermined communication quality level, it is determined that the communication quality level of the wireless LAN mobile station 1-1 to 1-N is smaller than the predetermined communication quality level.

The determination condition used for determining whether the wireless LAN mobile station 1-1 to 1-N is smaller than the predetermined communication quality level, on the basis of the four determination results in steps S45, S48, S51, and S54 may be suitably modified through an operation of the unit 204. As long as it is measured whether the wireless LAN mobile station 1-1 to 1-N is smaller than the predetermined communication quality level, on the basis of the four determination results in steps S45, S48, S51, and S54, various determination conditions may be suitably combined to be used as a determination condition for determining whether the communication quality level is smaller than the predetermined communication quality level.

In FIG. 13, the determination on whether the communication quality level of the wireless LAN mobile station 1-1 to 1-N is smaller than the predetermined communication quality level is made on the basis of the four determination results in the units 2061, 2062, 2063, and 2064. However, the determination on whether the communication quality level of the wireless LAN mobile station 1-1 to 1-N is smaller than the predetermined communication quality level may be made on the basis of at least one of the determination results in the units 2061, 2062, 2063, and 2064.

In this way, when provided with the unit 2064, the wireless LAN mobile station 1-1 to 1-N of the first embodiment makes a determination on whether the communication quality level of the wireless LAN mobile station 1-1 to 1-N is smaller than the predetermined communication quality level, on the basis of at least one of the determination results in the units 2061, 2062, 2063, and 2064.

In addition, when provided with the unit 2064 as shown in FIG. 14, the wireless LAN mobile station 1-1 to 1-N of the second embodiment allows the table 208 shown in FIG. 9 to construct the “unsatisfactory condition for the predetermined communication quality level” by suitably combining the four measurement results in the units 2061, 2062, 2063, and 2064 and to manage the “unsatisfactory condition for the predetermined communication quality level” so that the “unsatisfactory condition for the predetermined communication quality level” is correlated with the “RSSI value.” The table 208 manages the “unsatisfactory condition for the predetermined communication quality level” so that a poorer “unsatisfactory condition for the predetermined communication quality level” is correlated with a higher “RSSI value.”

As described above, the wireless LAN mobile station 1-1 to 1-N of the above-described embodiments may be configured to measure the communication quality level on the basis of at least one of the measurement results in the units 2601, 2602, 2603, and 2064. The basis for determining the communication quality level of the wireless LAN mobile station 1-1 to 1-N of the above-described embodiments is not limited to the above-mentioned four measurement results. The communication quality level of the wireless LAN mobile station 1-1 to 1-N may be measured on the basis of other information as long as the information is useful for measuring the communication quality level of the wireless LAN mobile station 1-1 to 1-N. For example, the communication quality level of the wireless LAN mobile station 1-1 to 1-N may be measured on the basis of audio quality information in accordance with PESQ standard (defined in ITU-T P.862).

The control operations in the wireless LAN mobile station 1-1 to 1-N of the above-described embodiments may be performed through software such as a computer program instead of a hardware configuration. The program may be recorded to a recording medium such as an optical recording medium, a magnetic recording medium, a magneto-optical recording medium, or a semiconductor storage medium, and then read from the recording medium into a communication device capable of wireless communication, thereby allowing the communication device to execute the above-described control operations. The control operations may be executed by the communication device by reading the program into the communication device from an external device connected to the communication device through a network. The control operations described in the above-described embodiments may be combined to each other.

The wireless LAN mobile station, the wireless LAN system, and the method and program of controlling a handover, related to the invention may be applied to a communication device capable of wireless communication such as a cellular phone, a PDA (Personal Digital Assistance), or a PC (Personal Computer).

While the invention has been described in terms of several exemplary embodiments, those skilled in the art will recognize that the invention can be practiced with modification within the spirit and scope of the appended claims.

Further, it is noted that Applicant's intent is to encompass equivalents of all claim elements, even if amended later during prosecution.

What is claimed is:

1. A wireless LAN mobile station, comprising:
a received signal strength measuring section that measures a value of a received signal strength indicator;
a handover executing section that compares the value of the received signal strength indicator with a threshold value serving as a criterion for executing a handover and executes the handover when the value of the received signal strength indicator is equal to or smaller than the threshold value;
a communication quality level measuring section that measures a communication quality level of information that is transmitted or received between the wireless LAN mobile station and an association device associated with the wireless LAN mobile station; and
a threshold value changing section that increases the threshold value by a predetermined value when the communication quality level is smaller than the predetermined communication quality level.

2. The wireless LAN mobile station according to claim 1, wherein the threshold value is changed to an initial value or decreased by a predetermined value when the communication quality level is equal to or greater than a predetermined communication quality level after the threshold value changing section increases the threshold value by a predetermined value.

3. A wireless LAN mobile station of claim 1, further comprising:
a managing section that manages an unsatisfactory condition for the predetermined communication quality level and the value of a received signal strength indicator so that they are correlated with each other,
wherein said threshold value changing section, when the communication quality level corresponds to the unsatisfactory condition for the predetermined communication quality level, acquires the received signal strength indicator value correlated with the unsatisfactory condition for the predetermined communication quality level, and changes the threshold value to the acquired received signal strength indicator value,
wherein the managing section manages the unsatisfactory condition for the predetermined communication quality level so that a poorer unsatisfactory condition for the predetermined communication quality level is correlated with a higher received signal strength indicator value, and
wherein, as the communication quality level corresponds to the poorer unsatisfactory condition for the predetermined communication quality level, the threshold value changing section changes the threshold value to a higher received signal strength indicator value.

4. The wireless LAN mobile station according to claim 1, wherein the communication quality level measuring section measures the communication quality level by using at least one of:
an SNR measuring section that measures an SNR (signal to noise ratio);
a BER measuring section that measures a BER (bit error rate);
a PER measuring section that measures a PER (packet error rate); and
a data retransmission rate measuring section that measures a data retransmission rate of information.

5. The wireless LAN mobile station according to claim 3, wherein the communication quality level measuring section measures the communication quality level by using at least one of:
an SNR measuring section that measures an SNR (signal to noise ratio);
a BER measuring section that measures a BER (bit error rate);
a PER measuring section that measures a PER (packet error rate); and
a data retransmission rate measuring section that measures a data retransmission rate of information.

6. The wireless LAN mobile station according to claim 4, wherein the threshold value changing section is configured to determine at least one of:
the communication quality level is smaller than the predetermined communication quality level when the SNR is determined to be equal to or smaller than the predetermined threshold value, and the communication quality level is equal to or greater than the predetermined communication quality level when the SNR is determined to be greater than the predetermined threshold value;
the communication quality level is smaller than the predetermined communication quality level when the BER is determined to be equal to or smaller than the predetermined threshold value, and the communication quality level is equal to or greater than the predetermined communication quality level when the BER is determined to be greater than the predetermined threshold value;
the communication quality level is smaller than the predetermined communication quality level when the PER is determined to be equal to or smaller than the predetermined threshold value, and the communication quality level is equal to or greater than the predetermined communication quality level when the PER is determined to be greater than the predetermined threshold value; and
the communication quality level is smaller than the predetermined communication quality level when the data retransmission rate is determined to be equal to or smaller than the predetermined threshold value, and the communication quality level is equal to or greater than the predetermined communication quality level when the data retransmission rate is determined to be greater than the predetermined threshold value.

7. The wireless LAN mobile station according to claim 5, wherein the threshold value changing section is configured to determine at least one of:
the communication quality level is smaller than the predetermined communication quality level when the SNR is determined to be equal to or smaller than the predetermined threshold value, and the communication quality level is equal to or greater than the predetermined communication quality level when the SNR is determined to be greater than the predetermined threshold value;
the communication quality level is smaller than the predetermined communication quality level when the BER is determined to be equal to or smaller than the predetermined threshold value, and the communication quality level is equal to or greater than the predetermined communication quality level when the BER is determined to be greater than the predetermined threshold value;
the communication quality level is smaller than the predetermined communication quality level when the PER is determined to be equal to or smaller than the predetermined threshold value, and the communication quality level is equal to or greater than the predetermined communication quality level when the PER is determined to be greater than the predetermined threshold value; and
the communication quality level is smaller than the predetermined communication quality level when the data retransmission rate is determined to be equal to or smaller than the predetermined threshold value, and the communication quality level is equal to or greater than the predetermined communication quality level when the data retransmission rate is determined to be greater than the predetermined threshold value.

8. The wireless LAN mobile station according to claim 1, further comprising a threshold value change determining section that determines whether the threshold value changing section is to change the threshold value.

9. The wireless LAN mobile station according to claim 3, further comprising a threshold value change determining section that determines whether the threshold value changing section is to change the threshold value.

10. The wireless LAN mobile station according to claim 8,
wherein the threshold value change determining section allows the threshold value changing section to change the threshold value when a radio signal of which the received signal strength indicator value is greater than that of an associated device associated with the wireless LAN mobile station has been received by the wireless LAN mobile station.

11. The wireless LAN mobile station according to claim 9,
wherein the threshold value change determining section allows the threshold value changing section to change the threshold value when a radio signal of which the received signal strength indicator value is greater than that of an associated device associated with the wireless LAN mobile station has been received by the wireless LAN mobile station.

12. A wireless LAN system comprising a plurality of wireless LAN base stations and a wireless LAN mobile station located under the plurality of wireless LAN base stations,
wherein the wireless LAN mobile station comprises:
a received signal strength measuring section that measures a value of a received signal strength indicator;
a handover executing section that compares the value of the received signal strength indicator with a threshold value serving as a criterion for executing a handover and executes the handover when the value of the received signal strength indicator is equal to or smaller than the threshold value;
a communication quality level measuring section that measures a communication quality level of information that is transmitted or received between the wireless LAN mobile station and an association device associated with the wireless LAN mobile station; and
a threshold value changing section that increases the threshold value by a predetermined value when the communication quality level measured by the communication quality level measuring section is smaller than the predetermined communication quality level.

13. The wireless LAN system according to claim 12, wherein the threshold value is changed to an initial value or is decreased by a predetermined value when the communication quality level is equal to or greater than a predetermined communication quality level after the wireless LAN mobile station increases the threshold value by a predetermined value.

14. A wireless LAN system comprising a plurality of wireless LAN base stations and a wireless LAN mobile station located under the plurality of wireless LAN base stations,
wherein the wireless LAN mobile station comprises:
a received signal strength measuring section that measures a value of a received signal strength indicator;
a handover executing section that compares the value of the received signal strength indicator with a threshold value serving as a criterion for executing a handover and executing the handover when the value of the received signal strength indicator is equal to or smaller than the threshold value;
a communication quality level measuring section that measures a communication quality level of information that is transmitted or received between the wireless LAN mobile station and an association device associated with the wireless LAN mobile station;
a managing section that manages an unsatisfactory condition for the predetermined communication quality level and the value of a received signal strength indicator so that they are correlated with each other; and
a threshold value changing section that, when the communication quality level corresponds to the unsatisfactory condition for the predetermined communication quality level, acquires the received signal strength indicator value correlated with the unsatisfactory condition for the predetermined communication quality level, and changes the threshold value to the acquired received signal strength indicator value,
wherein the managing section manages the unsatisfactory condition for the predetermined communication quality level so that a poorer unsatisfactory condition for the predetermined communication quality level is correlated with a higher received signal strength indicator value, and
wherein, as the communication quality level corresponds to the poorer unsatisfactory condition for the predetermined communication quality level, the threshold value changing section changes the threshold value to a higher received signal strength indicator value.

15. The wireless LAN system according to claim 12, wherein the wireless LAN mobile station measures the communication quality level by using at least one of:
an SNR measuring section that measures an SNR (signal to noise ratio);
a BER measuring section that measures a BER (bit error rate);
a PER measuring section that measures a PER (packet error rate); and
a data retransmission rate measuring section that measures a data retransmission rate of information.

16. The wireless LAN system according to claim 14, wherein the wireless LAN mobile station measures the communication quality level by using at least one of:
an SNR measuring section that measures an SNR (signal to noise ratio);
a BER measuring section that measures a BER (bit error rate);
a PER measuring section that measures a PER (packet error rate); and
a data retransmission rate measuring section that measures a data retransmission rate of information.

17. The wireless LAN system according to claim 15, wherein the wireless LAN mobile station determines one or more of:
the communication quality level is smaller than the predetermined communication quality level when the SNR is determined to be equal to or smaller than the predetermined threshold value, and the communication quality level is equal to or greater than the predetermined communication quality level when the SNR is determined to be greater than the predetermined threshold value;
the communication quality level is smaller than the predetermined communication quality level when the BER is determined to be equal to or smaller than the predetermined threshold value, and the communication quality level is equal to or greater than the predetermined communication quality level when the BER is determined to be greater than the predetermined threshold value;
the communication quality level is smaller than the predetermined communication quality level when the PER is determined to be equal to or smaller than the predetermined threshold value, and the communication quality level is equal to or greater than the predetermined communication quality level when the PER is determined to be greater than the predetermined threshold value; and
the communication quality level is smaller than the predetermined communication quality level when the data retransmission rate is determined to be equal to or smaller than the predetermined threshold value, and the communication quality level is equal to or greater than the predetermined communication quality level when the data retransmission rate is determined to be greater than the predetermined threshold value.

18. The wireless LAN system according to claim 16, wherein the wireless LAN mobile station determines one or more of:
the communication quality level is smaller than the predetermined communication quality level when the SNR is determined to be equal to or smaller than the predetermined threshold value, and the communication quality level is equal to or greater than the predetermined communication quality level when the SNR is determined to be greater than the predetermined threshold value;
the communication quality level is smaller than the predetermined communication quality level when the BER is determined to be equal to or smaller than the predetermined threshold value, and the communication quality level is equal to or greater than the predetermined communication quality level when the BER is determined to be greater than the predetermined threshold value;
the communication quality level is smaller than the predetermined communication quality level when the PER is determined to be equal to or smaller than the predetermined threshold value, and the communication quality level is equal to or greater than the predetermined communication quality level when the PER is determined to be greater than the predetermined threshold value; and
the communication quality level is smaller than the predetermined communication quality level when the data retransmission rate is determined to be equal to or smaller than the predetermined threshold value, and the communication quality level is equal to or greater than the predetermined communication quality level when the data retransmission rate is determined to be greater than the predetermined threshold value.

19. The wireless LAN system according to claim 12,
wherein the wireless LAN mobile station further comprises a threshold value change determining section that determines whether the threshold value changing section is to change the threshold value.

20. The wireless LAN system according to claim 14,
wherein the wireless LAN mobile station further comprises a threshold value change determining section that determines whether the threshold value changing section is to change the threshold value.

21. The wireless LAN system according to claim 19, wherein the wireless LAN mobile station allows the threshold value changing section to change the threshold value when a signal whose received signal strength indicator value is greater than that of an associated device associated with the wireless LAN mobile station has been received by the wireless LAN mobile station.

22. The wireless LAN system according to claim 20, wherein the wireless LAN mobile station allows the threshold value changing section to change the threshold value when a signal whose received signal strength indicator value is greater than that of an associated device associated with the wireless LAN mobile station has been received by the wireless LAN mobile station.

23. A method for controlling a handover in a wireless LAN mobile station in which the value of a received signal strength indicator is measured, the measured received signal strength indicator value is compared with a threshold value serving as a criterion for executing the handover, and the handover is executed when the received signal strength indicator value is equal to or smaller than the threshold value,
the method comprising:
a communication quality level measuring step of measuring a communication quality level of information which is transmitted or received between the wireless LAN mobile station and an association device associated with the wireless LAN mobile station; and
a threshold value changing step of increasing the threshold value by a predetermined value when the communication quality level measured by the communication quality level measuring step is smaller than a predetermined communication quality level.

24. The method according to claim 23, wherein the threshold value changing step is configured to change the threshold value to an initial value or decrease the threshold value by a predetermined value when the communication quality level is equal to or greater than a predetermined communication quality level after the threshold value is increased by a predetermined value.

25. A method of controlling a handover in a wireless LAN mobile station in which the value of a received signal strength indicator is measured, the measured received signal strength indicator value is compared with a threshold value serving as a criterion for executing the handover, and the handover is executed when the received signal strength indicator value is equal to or smaller than the threshold value,
wherein the wireless LAN mobile station includes a managing section that manages an unsatisfactory condition for the predetermined communication quality level and the value of a received signal strength indicator so that they are correlated with each other,
the method comprising:
a communication quality level measuring step of measuring a communication quality level of information that is transmitted or received between the wireless LAN mobile station and an association device associated with the wireless LAN mobile station; and
a threshold value changing step of, when the communication quality level measured corresponds to the unsatisfactory condition for the predetermined communication quality level, acquiring the received signal strength indicator value correlated with the unsatisfactory condition for the predetermined communication quality level, and changing the threshold value to the acquired received signal strength indicator value,
wherein the managing section manages the unsatisfactory condition for the predetermined communication quality level so that a poorer unsatisfactory condition for the predetermined communication quality level is correlated with a higher received signal strength indicator value, and
wherein, as the communication quality level corresponds to the poorer unsatisfactory condition for the predetermined communication quality level, the threshold value changing step is configured to change the threshold value to a higher received signal strength indicator value.

26. The method according to claim 23, wherein the communication quality level measuring step is configured to allow the wireless LAN mobile station to measure the communication quality level by using at least one of:
an SNR measuring step of measuring an SNR (signal to noise ratio);
a BER measuring step of measuring a BER (bit error rate);
a PER measuring step of measuring a PER (packet error rate); and
a data retransmission rate measuring step of measuring a data retransmission rate of information.

27. The method according to claim 25, wherein the communication quality level measuring step is configured to allow the wireless LAN mobile station to measure the communication quality level by using at least one of:
an SNR measuring step of measuring an SNR (signal to noise ratio);
a BER measuring step of measuring a BER (bit error rate);
a PER measuring step of measuring a PER (packet error rate); and
a data retransmission rate measuring step of measuring a data retransmission rate of information.

28. The method according to claim 26, wherein the threshold value changing step is configured to determine at least one of:
the communication quality level is smaller than the predetermined communication quality level when the SNR is determined to be equal to or smaller than the predetermined threshold value, and the communication quality level is equal to or greater than the predetermined communication quality level when the SNR is determined to be greater than the predetermined threshold value;
the communication quality level is smaller than the predetermined communication quality level when the BER is determined to be equal to or smaller than the predetermined threshold value, and the communication quality level is equal to or greater than the predetermined communication quality level when the BER is determined to be greater than the predetermined threshold value;
the communication quality level is smaller than the predetermined communication quality level when the PER is determined to be equal to or smaller than the predetermined threshold value, and the communication quality level is equal to or greater than the predetermined communication quality level when the PER is determined to be greater than the predetermined threshold value; and
the communication quality level is smaller than the predetermined communication quality level when the data retransmission rate is determined to be equal to or smaller than the predetermined threshold value, and the communication quality level is equal to or greater than the predetermined communication quality level when the data retransmission rate is determined to be greater than the predetermined threshold value.

29. The method according to claim 27, wherein the threshold value changing step is configured to determine at least one of:
the communication quality level is smaller than the predetermined communication quality level when the SNR is determined to be equal to or smaller than the predetermined threshold value, and the communication quality level is equal to or greater than the predetermined communication quality level when the SNR is determined to be greater than the predetermined threshold value;
the communication quality level is smaller than the predetermined communication quality level when the BER is determined to be equal to or smaller than the predetermined threshold value, and the communication quality level is equal to or greater than the predetermined communication quality level when the BER is determined to be greater than the predetermined threshold value;
the communication quality level is smaller than the predetermined communication quality level when the PER is determined to be equal to or smaller than the predetermined threshold value, and the communication quality level is equal to or greater than the predetermined communication quality level when the PER is determined to be greater than the predetermined threshold value; and
the communication quality level is smaller than the predetermined communication quality level when the data retransmission rate is determined to be equal to or smaller than the predetermined threshold value, and the communication quality level is equal to or greater than the predetermined communication quality level when the data retransmission rate is determined to be greater than the predetermined threshold value.

30. The method according to claim 23, further comprising a threshold value change determining step of determining whether to change the threshold value in the threshold value changing step.

31. The method according to claim 25, comprising a threshold value change determining step of determining whether to change the threshold value in the threshold value changing step.

32. The method according to claim 30, wherein the threshold value change determining step is configured to change the threshold value in the threshold value changing step when a radio signal of which the received signal strength indicator value is greater than that of an associated device associated with the wireless LAN mobile station has been received by the wireless LAN mobile station.

33. The method according to claim 31, wherein the threshold value change determining step is configured to change the threshold value in the threshold value changing step when a radio signal of which the received signal strength indicator value is greater than that of an associated device associated with the wireless LAN mobile station has been received by the wireless LAN mobile station.

34. A computer program of machine-readable instructions tangibly embodied in a medium, for controlling a handover in a wireless LAN mobile station in which a value of a received signal strength indicator is measured, the measured received signal strength indicator value is compared with a threshold value serving as a criterion for executing the handover, and the handover is executed when the received signal strength indicator value is equal to or smaller than the threshold value, the program causing a computer to perform:
a communication quality level measuring operation of measuring a communication quality level of information which is transmitted or received between the wireless LAN mobile station and an association device associated with the wireless LAN mobile station; and
a threshold value changing operation of increasing the threshold value by a predetermined value when the communication quality level measured by the communication quality level measuring operation is smaller than a predetermined communication quality level.

35. The computer program according to claim 34, wherein the threshold value changing operation is configured to change the threshold value to an initial value or decrease the threshold value by a predetermined value when the communication quality level measured by the communication quality level measuring operation is equal to or greater than a predetermined communication quality level after the threshold value is increased by a predetermined value.

36. A computer program of machine-readable instructions tangibly embodied in a medium, for controlling a handover in a wireless LAN mobile station in which a value of a received signal strength indicator is measured, the measured received signal strength indicator value is compared with a threshold value serving as a criterion for executing the handover, and the handover is executed when the received signal strength indicator value is equal to or smaller than the threshold value,
wherein the wireless LAN mobile station includes managing section that manages an unsatisfactory condition for the predetermined communication quality level and the value of a received signal strength indicator so that they are correlated with each other,
wherein the program causes a computer to perform:
a communication quality level measuring operation of measuring a communication quality level of information which is transmitted or received between the wireless LAN mobile station and an association device associated with the wireless LAN mobile station; and
a threshold value changing operation of, when the communication quality level measured by the communication quality level measuring operation corresponds to the unsatisfactory condition for the predetermined communication quality level, acquiring the received signal strength indicator value correlated with the unsatisfactory condition for the predetermined communication quality level, and changing the threshold value to the acquired received signal strength indicator value,
wherein the managing section manages the unsatisfactory condition for the predetermined communication quality level so that a poorer unsatisfactory condition for the predetermined communication quality level is correlated with a higher received signal strength indicator value, and
wherein, as the communication quality level measured in the communication quality level measuring operation corresponds to the poorer unsatisfactory condition for the predetermined communication quality level, the threshold value changing operation is configured to change the threshold value to a higher received signal strength indicator value.

37. The computer program according to claim 34, wherein the communication quality level measuring operation is configured to allow the wireless LAN mobile station to measure the communication quality level by using at least one of:
an SNR measuring operation of measuring an SNR (signal to noise ratio);
a BER measuring operation of measuring a BER (bit error rate);
a PER measuring operation of measuring a PER (packet error rate); and
a data retransmission rate measuring operation of measuring a data retransmission rate of information.

38. The computer program according to claim 36, wherein the communication quality level measuring operation is configured to allow the wireless LAN mobile station to measure the communication quality level by using at least one of:
an SNR measuring operation of measuring an SNR (signal to noise ratio);
a BER measuring operation of measuring a BER (bit error rate);
a PER measuring operation of measuring a PER (packet error rate); and
a data retransmission rate measuring operation of measuring a data retransmission rate of information.

39. The computer program according to claim 37, wherein the threshold value changing operation is configured to determine at least one of:
the communication quality level is smaller than the predetermined communication quality level when the SNR measured in the SNR measuring operation is determined to be equal to or smaller than the predetermined threshold value, and the communication quality level is equal to or greater than the predetermined communication quality level when the SNR measured in the SNR measuring operation is determined to be greater than the predetermined threshold value;
the communication quality level is smaller than the predetermined communication quality level when the BER measured in the BER measuring operation is determined to be equal to or smaller than the predetermined threshold value, and the communication quality level is equal to or greater than the predetermined communication quality level when the BER measured in the BER measuring operation is determined to be greater than the predetermined threshold value;
the communication quality level is smaller than the predetermined communication quality level when the PER measured in the PER measuring operation is determined to be equal to or smaller than the predetermined threshold value, and the communication quality level is equal to or greater than the predetermined communication quality level when the PER measured in the PER measuring operation is determined to be greater than the predetermined threshold value; and
the communication quality level is smaller than the predetermined communication quality level when the data retransmission rate measured in the data retransmission rate measuring operation is determined to be equal to or smaller than the predetermined threshold value, and the communication quality level is equal to or greater than the predetermined communication quality level when the data retransmission rate measured in the data retransmission rate measuring operation is determined to be greater than the predetermined threshold value.

40. The computer program according to claim 38, wherein the threshold value changing operation is configured to determine at least one of:
the communication quality level is smaller than the predetermined communication quality level when the SNR measured in the SNR measuring operation is determined to be equal to or smaller than the predetermined threshold value, and the communication quality level is equal to or greater than the predetermined communication quality level when the SNR measured in the SNR measuring operation is determined to be greater than the predetermined threshold value;
the communication quality level is smaller than the predetermined communication quality level when the BER measured in the BER measuring operation is determined to be equal to or smaller than the predetermined threshold value, and the communication quality level is equal to or greater than the predetermined communication quality level when the BER measured in the BER measuring operation is determined to be greater than the predetermined threshold value;
the communication quality level is smaller than the predetermined communication quality level when the PER measured in the PER measuring operation is determined to be equal to or smaller than the predetermined threshold value, and the communication quality level is equal to or greater than the predetermined communication quality level when the PER measured in the PER measuring operation is determined to be greater than the predetermined threshold value; and
the communication quality level is smaller than the predetermined communication quality level when the data retransmission rate measured in the data retransmission rate measuring operation is determined to be equal to or smaller than the predetermined threshold value, and the communication quality level is equal to or greater than the predetermined communication quality level when the data retransmission rate measured in the data retransmission rate measuring operation is determined to be greater than the predetermined threshold value.

41. The computer program according to claim 34, the program further causing the computer to perform a threshold value change determining operation of determining whether to change the threshold value in the threshold value changing operation.

42. The computer program according to claim 36, the program further causing the computer to perform a threshold value change determining operation of determining whether to change the threshold value in the threshold value changing operation.

43. The computer program according to claim 41, wherein the threshold value change determining operation is configured to change the threshold value in the threshold value changing operation when a radio signal of which the received signal strength indicator value is greater than that of an associated device associated with the wireless LAN mobile station has been received by the wireless LAN mobile station.

44. The computer program according to claim 42, wherein the threshold value change determining operation is configured to change the threshold value in the threshold value changing operation when a radio signal of which the received signal strength indicator value is greater than that of an associated device associated with the wireless LAN mobile station has been received by the wireless LAN mobile station.
